(19) United States
(12) Patent Application Publication
(10) Pub. No.: US 2006/0293838 A1
(43) Pub. Date: Dec. 28, 2006

(54) Guidance apparatus

(76) Inventors: Kakuya Yamamoto, Hyogo (JP); Keiji Sugiyama, Kyoto (JP); Junichi Hirai, Osaka (JP)

Correspondence Address: WENDEROTH, LIND & PONACK L.L.P., 2033 K. STREET, NW, SUITE 800, WASHINGTON, DC, 20006, US

(21) Appl. No.: 11/448,731

(22) Filed: Jun. 8, 2006

(30) Foreign Application Priority Data
Jun. 13, 2005 (JP) 2005-171865
Jun. 13, 2005 (JP) 2005-171876

(51) Int. Cl. G01C 21/00

(52) U.S. Cl. 701/200; 701/211

(57) ABSTRACT

A guidance apparatus includes: a goal setting unit which sets a guidance goal of a user; a recognition unit which recognizes a situation of the user; a guidance tool obtainment unit which obtains a guidance tool for the user; a guidance plan making unit which makes a guidance plan by combining two or more guidance tools obtained; an execution unit which executes the guidance plan; and a presentation unit which presents a result of the execution to the user.

### BACKGROUND OF THE INVENTION

(1) Field of the Invention

The present invention relates to a guidance apparatus which guides a mental state of a user.

(2) Description of the Related Art

FIG. 1 is a block diagram of a conventional guidance apparatus. This guidance apparatus is an apparatus which presents a solution to a user immediately and assertively responding to a change in a user's situation or condition. The guidance apparatus functionally has a recognition unit 110, a guidance tool obtainment unit 120, a guidance tool adaptation selection unit 150, and a presentation unit 160.

The recognition unit 110 recognizes a situation and a condition of the user. The recognition result includes a current situation and a predicted situation of user's circumstances, a mental state of the user, information which the user is viewing and listening to, and the like.

The guidance tool obtainment unit 120 obtains plural guidance tools. The guidance tools are means for solving programs which the user faces. Such a guidance tool is sometimes previously stored in the guidance tool obtainment unit 120.

From the guidance tools obtained by the guidance tool obtainment unit 120, the guidance tool adaptation selection unit 150 selects a guidance tool which is suitable for the recognition result of the recognition unit 101. The presentation unit 160 presents information to the user, using the tool selected by the guidance tool adaptation selection unit 150.

The conventional guidance apparatus presents a solution to the user immediately and assertively responding to a change in a user's situation or condition, by repeating the above-described processing of recognizing, selecting, and presenting immediately and assertively responding to the change.

One example of the conventional guidance apparatus is a car navigation system which presents a driver a summary of a received electronic mail, when a driver seems busy, as disclosed in Japanese Patent Application Laid-Open No. 2004-80066, for example. This car navigation system can reduce inconvenience of presenting electronic mail by an unsuitable method to a busy driver.

Another example of the conventional guidance apparatus is a stress coping apparatus which detects a stress of a user using a sensor, and automatically and assertively presents the user a suitable stress coping measure (advice for deep breathing, energy drink purchase, or the like), as disclosed in Japanese Patent Application Laid-Open No. 2001-344352, for example. This car stress coping apparatus can reduce inconvenience of presenting a stress coping measure unsuitable for a user's situation.

The conventional guidance apparatus performs the solution immediately and assertively responding to a user's situation. However, such guidance tool is not appropriate in some applications. For example, in order to increase user's willingness to study English during commuting, the conventional guidance apparatus encourages the user to start studying, as soon as the user becomes in a situation where the user can study. This method is not suitable for the user, because the user is more likely to feel annoyed with such forceful guidance, and the guidance fails with a high possibility.

Thus, solutions proposed immediately and assertively responding to a user's situation are not always effective, depending on the applications. In other words, guidance for user's mental state sometimes needs to take a medium or long term, such as some minutes, or several days. However, the conventional guidance apparatuses present solutions only immediately and assertively responding to situations, failing to guide a user's mental state appropriately.

### SUMMARY OF THE INVENTION

In order to solve the above problem, an object of the present invention is to provide a guidance apparatus which can guide a user's mental state in a medium or long term, by guiding the user systematically and gradually.

In order to achieve the above object, the guidance apparatus according to the present invention guides a mental state of a user. The apparatus includes: a goal setting unit which sets a guidance goal of the user; a recognition unit which recognizes a situation of the user; a guidance tool obtainment unit which obtains a guidance tool for the user; a guidance plan making unit which makes at least one guidance plan which matches the recognized situation and the set guidance goal, by combining two or more guidance tools obtained; an execution unit which executes the made guidance plan; and a presentation unit which presents a result of the execution of the guidance plan.

Thereby, the made guidance plan includes plural guidance tools, so that it is possible to guide the user systematically and gradually. Thus, it is possible to perform guidance to reach near the goal in a medium or long term, although the goal is far in a short term.

Here, the guidance plan making unit may include: a guidance plan generating unit which generates at least one guidance plan; and a mental state change prediction unit which predicts a change in the mental state of the user, which should be caused when the guidance plan is executed, and the execution unit may execute the guidance plan, which corresponds to the predicted change satisfying predetermined conditions, the corresponding predicted change being among the changes predicted by the mental state change prediction unit.

Thereby, a mental state change is predicted according to each of the generated plural guidance plans, so that a guidance plan is executed only when the prediction of the guidance plan satisfies predetermined conditions. Thus, for example, it is possible to previously perform guidance not to be too away from the guidance goal, in consideration of a limit of an effect of the guidance tool.

Further, the guidance apparatus may further include a mental state change rule obtainment unit which obtains a rule regarding the change in the mental state of the user, wherein the mental state change prediction unit predicts the change based on the obtained rule.

Thereby, it is possible not only to synthesize and generate various reaction prediction of the user's mental state according to the external world situations and the guidance tools, but also to predict a mental state change of the user based on rules such as psychological theories and empirical rules, which increasing quality of the prediction. In addition, the mental state change rule is obtained from the outside, so that the mental state change rule and the guidance apparatus can be separated.

Still further, the rule may be described by a formula for setting an upper limit to a changing speed of a prediction value of the mental state. Thereby, it is possible to prevent guidance causing sudden and heavy mental state resistance of the user.

Still further, the rule may be described by a formula for setting an upper limit to a total of the prediction values of the mental state in a predetermined time period.

Thereby, it is possible to prevent guidance causing a heavy time load on the user.

Still further, the rule may be described by a formula for restricting an increase of a prediction value of a second mental state, when a prediction value of a first mental state is equal to or greater than a predetermined value.

Thereby, it is possible to prevent guidance resulting in a waste and a small effect.

As described above, the guidance apparatus according to the present invention can make a guidance plan including plural guidance tools, thereby guiding the user systematically and gradually. Thus, it is possible to perform guidance to reach near the goal in a medium or long term, although the goal is far in a short term.

Still further, the guidance apparatus may further include an evaluation unit which evaluates the guidance plan, generated by the guidance plan generating unit, based on the predicted change in the mental state.

Thereby, the made guidance plan includes plural guidance tools, so that it is possible to guide the user systematically and gradually. Thus, it is possible to perform guidance to reach near the goal in a medium or long term, although the goal is far in a short term. In addition, the guidance plan is evaluated based on the predicted mental state change, so that it is possible to provide the user with a guidance plan having quality that is equal to or better than predetermined quality.

Still further, the evaluation unit may include a goal achievement evaluation unit which evaluates the predicted change based on the set guidance goal.

Thereby, it is possible to execute a guidance plan which matches the guidance goal.

Still further, the guidance apparatus may further include a mental state change rule obtainment unit which obtains a rule regarding the mental state of the user, wherein the evaluation unit includes a mental state resistance evaluation unit which evaluates a resistance in the mental state which should be caused by the predicted change in the mental state, based on the obtained rule.

Thereby, it is possible to execute a guidance plan resulting in less mental state resistance of the user. In addition, the mental state change rule is obtained from the outside, so that the mental state change rule and the guidance apparatus can be separated.

Still further, the guidance apparatus may further include a mental state change rule obtainment unit which obtains a rule regarding the mental state of the user, wherein the evaluation unit includes: a goal achievement evaluation unit which evaluates the predicted change based on the set guidance goal; a mental state resistance evaluation unit which evaluates a resistance of the mental state which should be caused by the predicted change in the mental state, based on the obtained rule; and a comprehensive evaluation unit which performs comprehensive evaluation, base on a result evaluated by the goal achievement evaluation unit, and a result evaluated by the mental state resistance evaluation unit.

Thereby, it is possible to guide the user's metal state, by taking a balance of (i) efficiency for the user's guidance goal and (ii) the mental state resistance which the user feels, without considering only the efficiency.

Still further, the goal achievement evaluation unit may evaluate the predicted change in the mental state, based on an estrangement degree between the predicted change and an ideal change in the mental state.

Thereby, it is possible to know at how much degree a mental state change caused by execution of a certain guidance plan matches the guidance goal.

Still further, the rule is described as a function which indicates the rule.

More specifically, the rule is a changing speed rule which indicates that a resistance of the mental state is being increased, when a value indicating a level of the mental state is being increased with a speed faster than a predetermined speed.

Thereby, it is possible to predict that the user should feel mental state resistance, when a changing degree of the user's mental state is over a predetermined value, for example when concentration is suddenly intensified.

Still further, the rule is a tension duration rule which indicates that the resistance of the mental state is caused in the user, when a value indicating a level of the mental state is greater than a predetermined value.

Thereby, it is possible to predict that the user should feel mental state resistance, when a value indicating a level of the user's mental state is over a predetermined value, for example when high concentration is kept.

Still further, the comprehensive evaluation unit may (i) assign different weighting coefficients to a result evaluated by the goal achievement evaluation unit and a result evaluated by the mental state resistance evaluation unit, respectively, depending on the set guidance goal, and (ii) perform comprehensive evaluation base on the weighting coefficients.

Thereby, it is possible to change a principle indicating which is to be more important, achievement for the user's guidance goal, or reduction of the user's mental state resistance.

As described above, the guidance apparatus according to the present invention can make a guidance plan including plural guidance tools, thereby guiding the user systematically and gradually. Thus, it is possible to perform guidance to reach near the goal in a medium or long term, although the goal is far in a short term. In addition, the guidance plan is evaluated based on the predicted mental state change, so that it is possible to provide the user with a guidance plan having quality that is equal to or better than predetermined quality.

More specifically, the recognition unit recognizes the situation of the user, using one of a camera, a global positioning system (GPS), an acceleration sensor, an angle sensor, a magnetic sensor, or an electronic tag sensor. Still further, the guidance plan making unit makes the guidance plan, by selecting two or more guidance tools from the guidance tools obtained by the guidance tool obtainment unit, and deciding a time period for executing the selected guidance tools. Still further, the execution unit executes the guidance plan, by reproducing one of video and audio.

Note that the present invention can be realized not only as the above-described guidance apparatus, but also as a guidance method having processing performed by the units in the guidance apparatus, a program causing a computer to execute the processing, and the like. Here, it is obvious that the program can be distributed via a recording medium such as a CD-ROM or a transmission medium such as the Internet.

### FURTHER INFORMATION ABOUT TECHNICAL BACKGROUND TO THIS APPLICATION

The disclosure of Japanese Patent Application Nos. 2005-171865 and 2005-171876 filed on Jun. 13, 2005 including specification, drawings and claims are incorporated herein by reference in its entirety.

### BRIEF DESCRIPTION OF THE DRAWINGS

These and other objects, advantages and features of the invention will become apparent from the following description thereof taken in conjunction with the accompanying drawings that illustrate specific embodiments of the present invention. In the Drawings:

FIG. 1 is a block diagram of a conventional guidance apparatus;

FIG. 2 is a view showing a situation where a user wears a HMD according to the present invention;

FIG. 3 is a view showing a situation where a user wears another HMD according to the present invention;

FIG. 4 is a block diagram of a guidance apparatus according to the first embodiment of the present invention;

FIG. 5 is a block diagram of a guidance apparatus according to the first embodiment of the present invention;

FIG. 6 is a diagram showing presentation examples of guidance tools according to the first embodiment of the present invention;

FIG. 7 is a flowchart of processing performed by the guidance apparatus according to the first embodiment of the present invention;

FIG. 8 is a table indicating guidance tools according to the first embodiment of the present invention;

FIG. 9A is a table indicating a guidance plan according to the first embodiment of the present invention;

FIG. 9B is a table indicating another guidance plan according to the first embodiment of the present invention;

FIG. 10 is a table indicating mental state reaction prediction rules according to the first embodiment of the present invention;

FIG. 11A is a table indicating mental state prediction according to the first embodiment of the present invention;

FIG. 11B is a table indicating another mental state prediction according to the first embodiment of the present invention;

FIG. 12 is a table indicating a mental state change rule according to the first embodiment of the present invention;

FIG. 13A is a table indicating mental state prediction according to the first embodiment of the present invention;

FIG. 13B is a table indicating another mental state prediction according to the first embodiment of the present invention;

FIG. 14A is a table indicating a guidance plan according to the second embodiment of the present invention;

FIG. 14B is a table indicating another guidance plan according to the second embodiment of the present invention;

FIG. 15A is a table indicating mental state prediction according to the second embodiment of the present invention;

FIG. 15B is a table indicating another mental state prediction according to the second embodiment of the present invention;

FIG. 16 is a table indicating a mental state change rule according to the second embodiment of the present invention;

FIG. 17A is a table indicating mental state prediction according to the second embodiment of the present invention;

FIG. 17B is a table indicating another mental state prediction according to the second embodiment of the present invention;

FIG. 18A is a table indicating a guidance plan according to the third embodiment of the present invention;

FIG. 18B is a table indicating another guidance plan according to the third embodiment of the present invention;

FIG. 19A is a table indicating mental state prediction according to the third embodiment of the present invention;

FIG. 19B is a table indicating another mental state prediction according to the third embodiment of the present invention;

FIG. 20 is a table indicating a mental state change rule according to the third embodiment of the present invention;

FIG. 21A is a table indicating mental state prediction according to the third embodiment of the present invention;

FIG. 21B is a table indicating another mental state prediction according to the third embodiment of the present invention;

FIG. 22 is a block diagram of a whole guidance apparatus according to the fourth embodiment of the present invention;

FIG. 23 is a flowchart of processing performed by the guidance apparatus according to the fourth embodiment of the present invention;

FIG. 24 is a table indicating a behavior schedule of a user;

FIG. 25 is a table indicating examples of guidance tools;

FIG. 26 is a table indicating guidance plan structures;

FIG. 27A is a graph showing an example of execution of a guidance plan;

FIG. 27B is a graph showing another example of execution of the guidance plan;

FIG. 28A is a graph showing an example of mental state influence data;

FIG. 28B is a graph showing another example of mental state influence data;

FIG. 28C is a graph showing still another example of mental state influence data;

FIG. 29A is a formula of an example of a mental state change prediction for a guidance plan;

FIG. 29B is a graph showing the example of the mental state change prediction for the guidance plan;

FIG. 29C is a formula of another example of a mental state change prediction for a guidance plan;

FIG. 29D is a graph showing the another example of the mental state change prediction for the guidance plan;

FIG. 30 is a table indicating ideal mental state values depending on guidance goals;

FIG. 31 is a graph showing an example of ideal mental state changes;

FIG. 32 shows a means of evaluating the guidance plane using the ideal mental state change;

FIG. 33A is a graph showing an example of evaluation of the guidance plane using the ideal mental state change;

FIG. 33B is a graph showing another example of evaluation of the guidance plane using the ideal mental state change;

FIG. 34 is a table indicating an example of a mental state change rule;

FIG. 35 shows the mental state change rule expressed by a mathematical formula;

FIG. 36 shows the mental state change rule expressed by a mathematical formula;

FIG. 37A is a graph showing an example of mental state resistance prediction based on the mental state change rule;

FIG. 37B is a graph showing another example of mental state resistance prediction based on the mental state change rule;

FIG. 37C is a graph showing still another example of mental state resistance prediction based on the mental state change rule;

FIG. 37D is a graph showing still another example of mental state resistance prediction based on the mental state change rule;

FIG. 38 shows a means of evaluating the guidance plan based on the mental state resistance;

FIG. 39A is a graph showing an example of evaluation of the guidance plan based on the mental state resistance;

FIG. 39B is a graph showing another example of evaluation of the guidance plan based on the mental state resistance;

FIG. 40A is a table indicating importance degree determination;

FIG. 40B is a table indicating importance degree determination;

FIG. 41 is a diagram showing examples of calculating comprehensive evaluation; and

FIG. 42 is a diagram showing a GUI for setting a guidance goal.

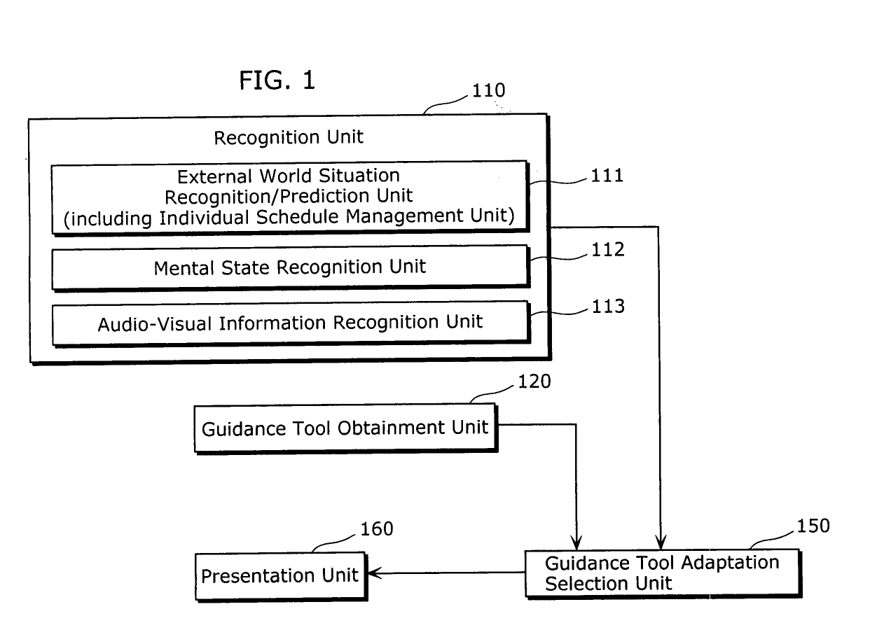

### DESCRIPTION OF THE PREFERRED EMBODIMENT(S)

The following describes embodiments according to the present invention with reference to the drawings.

### First Embodiment

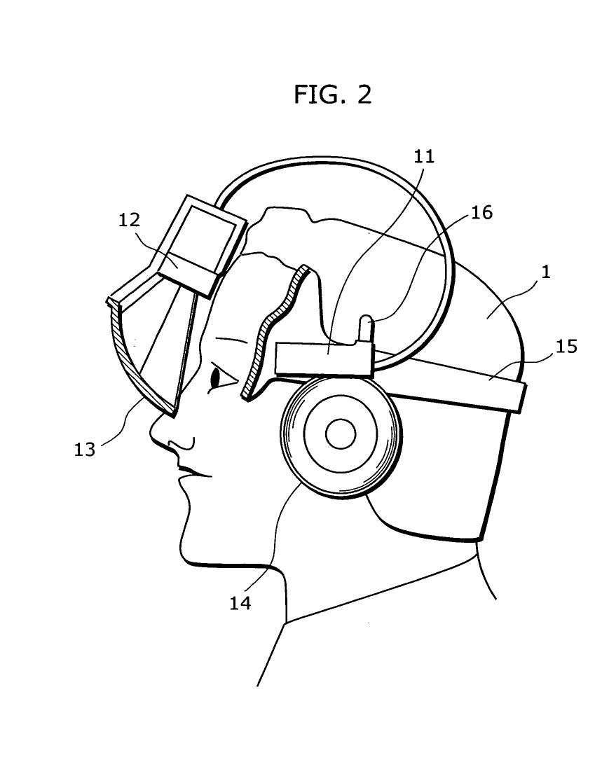

FIG. 2 is a view showing a situation where a user wears an HMD (Head Mounted Display) according to the present invention. This HMD is a guidance apparatus having the shape of goggles or a helmet. The HMD includes: a calculator 11 for performing various kinds of control for presenting information to a user; a display device 12 such as a Liquid Crystal Display (LCD); an optical device (presentation screen) 13 arranged within the view of the user; a pair of headphones 14 for audio guidance; a mounting member 15 for mounting the HMD on the head of the user 1; and a receiver 16 for receiving presented information from the Internet or the like.

One surface of the optical device 13 is a concave aspheric surface. A half mirror film is applied thereon and thereby reflects information displayed on the display device 12 so as to form a virtual image. On the other hand, the other surface of the optical device 13 is a convex aspheric surface and allows observation of the external world. Thus, the user views the information displayed on the display device 12 in a manner overlapped with the external world.

FIG. 3 is a view showing a situation where a user wears another HMD according to the present invention. In place of the receiver 16 shown in FIG. 2, this HMD has: a storing unit 18 for storing to-be-presented information in advance; and a cable 17 for connecting the storing unit 18 to the calculator 11. For example, the storing unit 18 may be implemented by a personal computer. Further, the personal computer may be connected to a Local Area Network (LAN), the Internet, or the like.

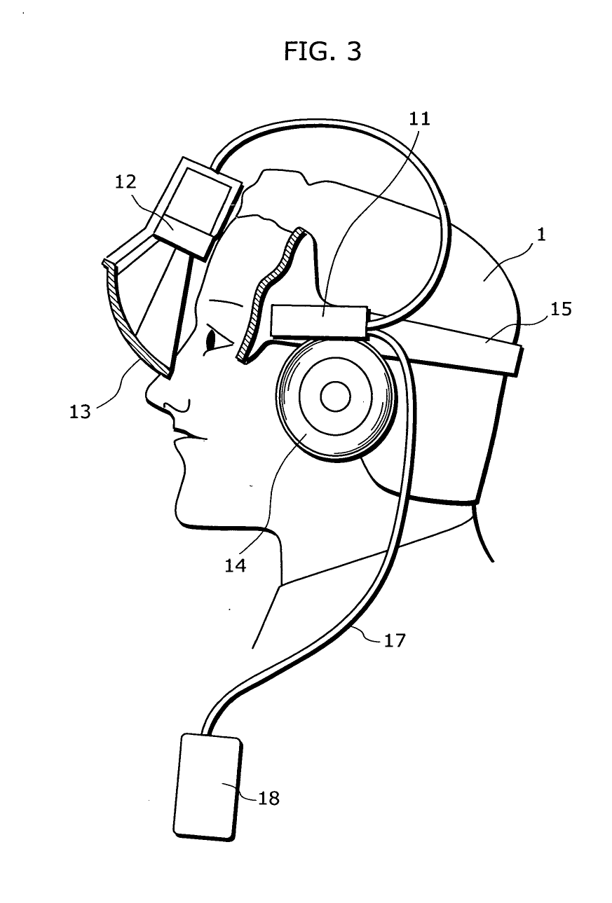

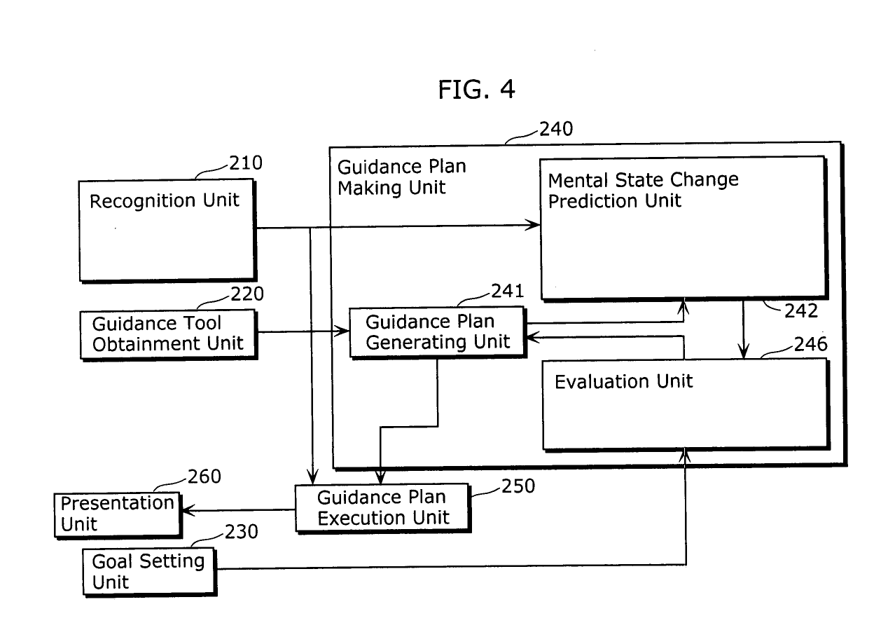

FIG. 4 is a block diagram of a guidance apparatus according to the first embodiment of the present invention. This guidance apparatus is a device for guiding the mental state of a user. The guidance apparatus functionally includes a recognition unit 210, a guidance tool obtainment unit 220, a goal setting unit 230, a guidance plan making unit 240, a guidance plan execution unit 250, and a presentation unit 260.

Examples of the recognition unit 210 are a camera, a Global Positioning System (GPS), an acceleration sensor, an angle sensor, a magnetic sensor, an electronic tag sensor or the like, for recognizing the situation and the condition of the user (simply referred to as “the situation of the user”, hereinafter). The recognition unit 210 includes an external world situation recognition and prediction unit, a mental state recognition unit, and an audio-visual information recognition unit, which are described below.

The external world situation recognition and prediction unit recognizes the external world situation around the user. The external world situation around the user is information characterizing a place, an object, a person, and an event around the user. Examples of the external world situation are: a behavior situation such as a position of a user, a current time, a sitting state, a walking state, a walking speed, and a walking direction; a physical condition such as a direction of eyes, a position of a hand, a body temperature, and a sweating condition; the five-sense information which the user senses, such as an object or a scene which the user sees, and a voice and a sound which the user hears; existence of an object and a person around the user, and an attribute of the existence; an event happened around the user such as product selling or neighbor's fire; an apparatus such as an HMD or headphones, which the user is mounting or carrying, and a condition or attribute of the apparatus; and weather conditions such as a temperature, sunlight, or rain. In addition to the current external world situation, historical data indicating past external world situations and schedule data indicating future external world situations may be included. These external world situations may be obtained from the GPS, the camera, the microphone, or various kinds of sensors such as the acceleration sensor, the angle sensor, or the electronic tag sensor. Alternatively, these situations obtained from an information providing device on the Internet.

The mental state recognition unit recognizes the mental state of the user. The mental state of a user is information indicating the mental state of a user. Examples of the mental state are study willingness for English, willingness for a certain behavior or goal, motivation, stress, irritation, delight, anger, sorrow, pleasure, anxiety and relief, likes and dislikes, interest, curiosity, boredom, satisfaction, sensation, caution, devotion, comfort and discomfort, calmness, instability, excitement, rest, coolness, respect, disdain, gratitude, superiority, shame, sleepiness, depression and aggression, tension, and love. In addition to the current mental state, the past mental state and the future mental state may be included as the mental state. Such a mental state may be obtained from a biosensor, or may be gussed from a result of questionnaire to the user, a reaction of the user to particular information, event, object, or person, or the external world situation described above.

The audio-visual information recognition unit recognizes information watched or listened to by the user. Examples of the audio-visual information are a television program, a music, a received electronic mail, news, a photograph, a video, characters, symbols, signals, a cartoon character, voice, and BGM. In addition to the information currently watched or listened, information watched or listened in the past and information to be watched or listened in the future may be included as the audio-visual information. Further, sense information of touch, smell, and taste, except visual and auditory senses may be included. Such audio-visual information may be obtained from an apparatus that presents the audio-visual information, or alternatively may be extracted from meta data assigned to the audio-visual information. Further, the audio-visual information may be inferred by analyzing the audio-visual information.

The guidance tool obtainment unit 220 obtains a guidance tool. The guidance tool is a means for changing the mental state of the user and includes: guiding information which is information for guiding the mental state of the user; and a guidance technique which is a technique for presenting the guiding information. Examples of the guiding information are: audio-visual information, such as a television program, voice, BGM, a message, an advice, a CM, a sound effect, a cartoon character, music, or color; touch information such as vibration or pressure; taste information; and smell information. Examples of the guidance techniques are: a change of a reproduction condition, such as a temporal stop, reproduction, forwarding, or slow reproduction; the number of reproductions; a reproduction frequency; a reproduction time period; a reproduction start time; a size, a position, color, transparency, depth of presentation; a detail degree, a summary degree, and an amount of information of presented information; presentation related to time or content; and presentation corresponding to the external world or a mental state.

The goal setting unit 230 sets a guidance goal of a user. The guidance goal may be a goal concerning the behavior of the user, a goal concerning the external world situation, and a goal concerning the mental state. Alternatively, these goals may be combined. An object of the goal may be reaching a physical point, change of a body weight and a body shape, a mark of an English examination, willingness for studying English, study willingness in a train during commuting. The setting of a guidance goal may be performed by the user oneself or alternatively a person other than the user such as a family member, an acquaintance, or a guidance service provider. Alternatively, the guidance apparatus may automatically guess a goal and set the goal. Further, these may be combined.

The guidance plan making unit 240 combines two or more guidance tools obtained by the guidance tool obtainment unit 220, and thereby makes a guidance plan which matches the situation of the user recognized by the recognition unit 210 and the guidance goal set by the goal setting unit 230. The guidance plan may include: a time indicating a timing of guidance execution; a condition when executing guidance; an external world situation; a mental state; audio-visual information; and a probability like “the guidance plan is executed at a probability of 20%”. A method of designating a guidance tool that constitutes the guidance plan is not limited to a particular one. That is, it is not necessary to designate a specific guidance tool directly. Alternatively, it is also possible to designate a set of guidance tools and instructs to “use any one of the guidance tools belonging to the set”. The guidance plan making unit 240 includes a guidance plan generating unit 241, a mental state change prediction unit 242, and an evaluation unit 246, which are described below.

The guidance plan generating unit 241 combines two or more guidance tools obtained by the guidance tool obtainment unit 220, and thereby generates a guidance plan. A detailed example of the guidance plan is described later.

On the basis of the recognition result obtained from the recognition unit 210, the mental state change prediction unit 242 predicts a mental state change, which is a change in the mental state of the user and would be caused when the guidance plan generated by the guidance plan generating unit 241 is executed. A detailed example of the prediction method is described later.

On the basis of the mental state change predicted by the mental state change prediction unit 242 (referred to as “mental state change prediction”, hereinafter) and the guidance goal set by the goal setting unit 230, the evaluation unit 246 evaluates the guidance plan generated by the guidance plan generating unit 241. A detailed example of the evaluation method is described later.

The guidance plan execution unit 250 executes the guidance plan made by the guidance plan generating unit 241. When the guidance plan is to be executed, the recognition result obtained from the recognition unit 210 is taken into consideration.

The presentation unit 260 presents to the user the result of the execution of the guidance plan execution unit 250. When the guidance tool has audio and video, an audio-visual presentation device such as an HMD or a projector may be employed as the presentation unit 260. In place of the HMD, a transmissive display, a face mounting display, a goggle-type display, a retinal scanning display or the like may be employed. Further, a unit for transmitting an instruction to a device different from the present guidance apparatus may be adopted as the presentation unit 260. The presentation unit 260 is not limited to an audio-visual presentation device and may be, for example, an air conditioner for sending wind to the user or alternatively a device for requesting a friend of the user for encouragement.

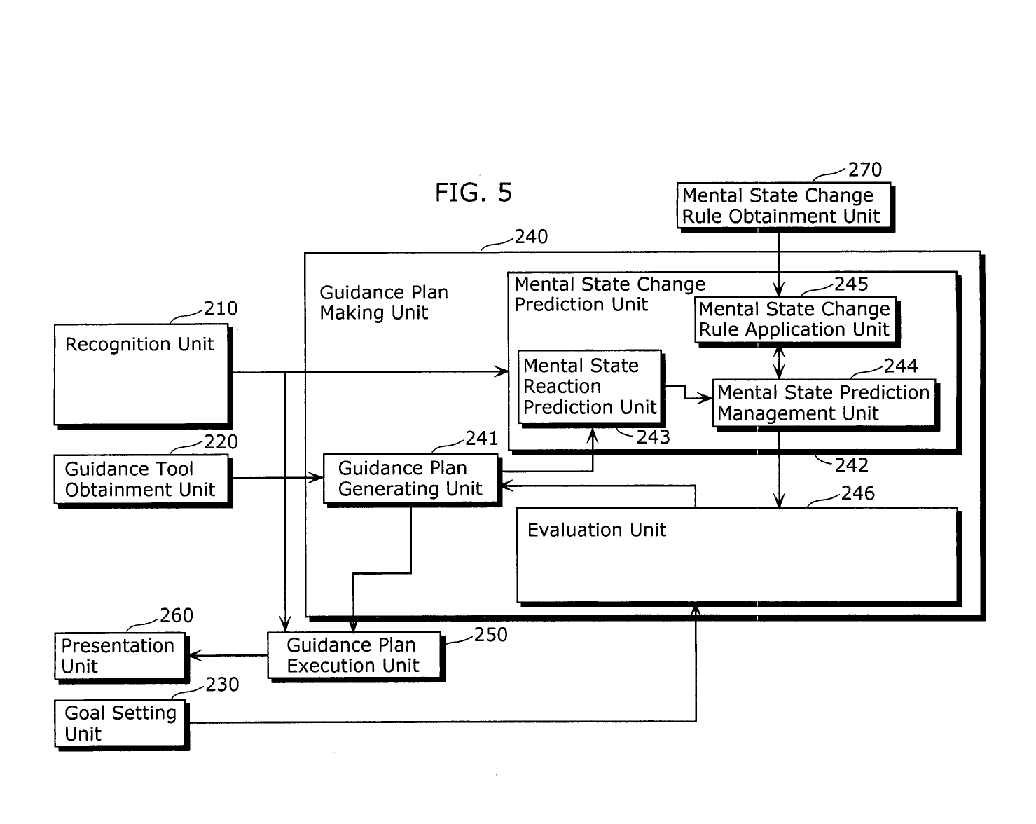

FIG. 5 is a block diagram showing details of the block diagram of FIG. 4.

The mental state change rule obtainment unit 270 obtains a mental state change rule which constrains a predicted change of the mental state of the user. The mental state prediction for the user indicates a future prediction recognized by the above-mentioned mental state recognition unit. Constraints on changes of prediction include: constraint on a freedom in increase and decrease, and maintaining of a prediction value; constraint on estrangement from a prediction value change pattern; constraint on a change of a future prediction value according to distribution of a past prediction value; a priority relationship regarding plural mental state prediction values, or increase and decrease of the values. A rule expressing such a constraint can be described by a formula that includes the mental state prediction value as a variable. A detailed example is described later.

The mental state change prediction unit 242 includes a mental state reaction prediction unit 243, a mental state prediction management unit 244, and a mental state change rule application unit 245, which are described below.

On the basis of the recognition result obtained from the recognition unit 210, the mental state reaction prediction unit 243 predicts a mental state reaction that would be caused in the user when the guidance plan generated by the guidance plan generating unit 241 is executed. The prediction may be a set of a plurality of predictions concerning the future, like a prediction for 1 minute later, a prediction for 2 minutes later, and a prediction for 3 minutes later. Further, the prediction may include: a plurality of candidates like “the mental state would become A or B”; a probability like “the mental state would become A at a probability of 30%”; or a condition like “the mental state would become A when the user gets on a train”.

The mental state reaction prediction unit 243 includes an external world reaction prediction unit, an automatic change prediction unit, and an information reaction prediction unit. The external world reaction prediction unit predicts a mental state change in response to an external world situation. The automatic change prediction unit predicts a change of the future mental state on the basis of the past or current mental state. The information reaction prediction unit predicts a mental state change in response to information watched or listened by the user and a mental state change in response to a guidance tool presented to the user. The prediction method employed in each unit is not limited to a particular one. For example, a predetermined rule may be adapted (described later). Alternatively, a neural network may be employed that learns a tendency of mental state change.

The mental state prediction management unit 244 manages the result predicted by the mental state reaction prediction unit 243. The mental state change rule application unit 245 adapts the mental state change rule obtained by the mental state change rule obtainment unit 270, and thereby modifies the prediction result managed by the mental state prediction management unit 244.

According to this configuration, a guidance plan consisting of a plurality of guidance tools can be made so that the user can be guided in a planed and stepwise manner. Further, a mental state change that would be caused when each of a plurality of the generated guidance plans is executed is predicted, and then these predictions are evaluated and compared with each other from the perspective of the guidance goal. This realizes predictive guidance.

Here, these units shown in FIGS. 4 and 5 may be or may be not provided on a single computer. For example, the entire units shown in FIG. 4 may be provided in a single HMD. Alternatively, the recognition unit 210 may be provided in another device. Further, the guidance plan making unit 240 may be a server device on the Internet. Further, a plurality of units may be provided for each kind of the units shown in FIGS. 4 and 5. For example, two presentation units 260 may be provided. Alternatively, a plurality of users may share the units shown in FIGS. 4 and 5.

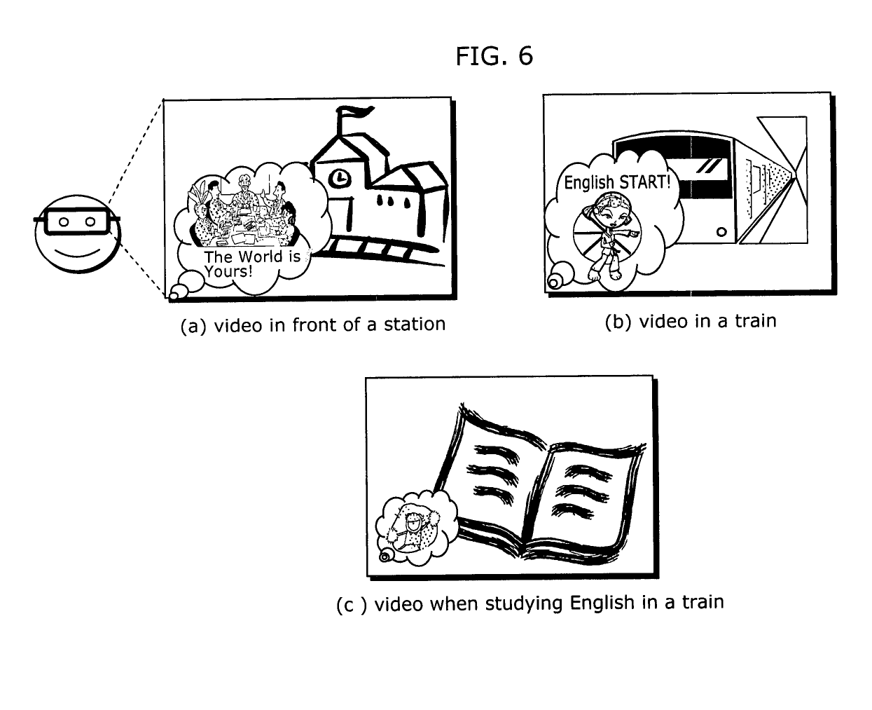

FIG. 6 is a diagram showing a detailed example of guidance. Here, it is assumed that a transmissive HMD, which is worn by a user during commuting, makes a guidance plan for improving the English studying willingness of the user. That is, when the commuting user wearing the transmissive HMD arrives at the front of a station, as shown in (a) of FIG. 6, a video containing a message such as “The world is yours!” is presented automatically. After that, when the user gets on a train, as shown in (b) of FIG. 6, a video containing a message such as “English start!” is presented automatically. After that, during the time that the user studies English on the train, as shown in (c) of FIG. 6, a video for cherring the studyting user is presented automatically.

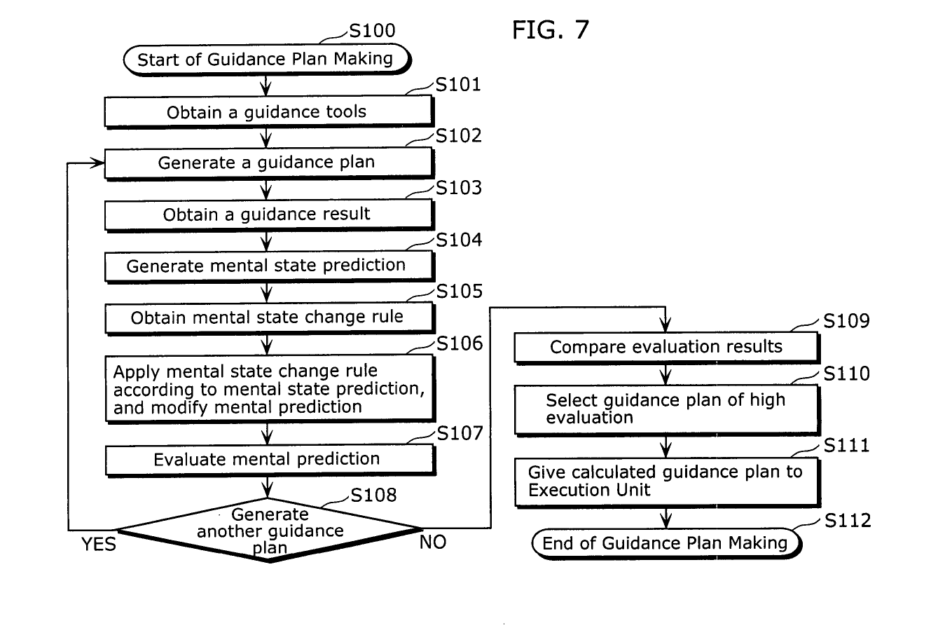

FIG. 7 is a flowchart showing processing performed by the guidance apparatus according to the first embodiment of the present invention. Here, FIG. 7 shows processing by which the guidance apparatus plans a future presentation operation in advance in order to implement the guidance example shown in FIG. 6.

The guidance plan making processing is started (S100).

The guidance plan generating unit 241 obtains guidance tools from the guidance tool obtainment unit 220 (S101).

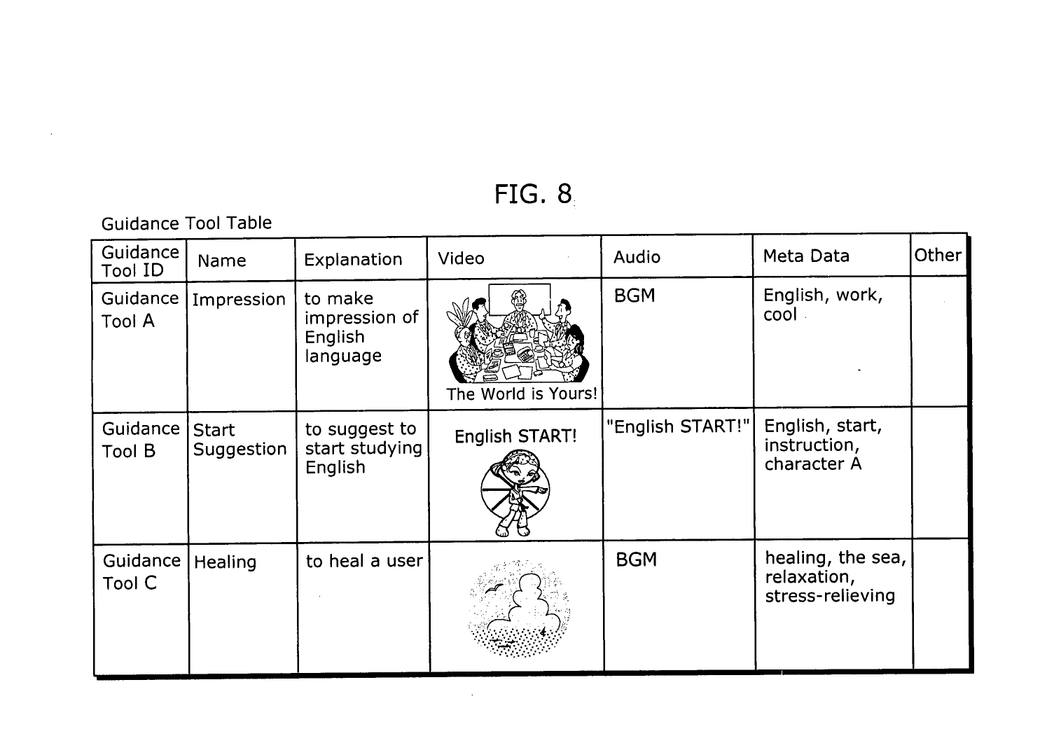

FIG. 8 shows an example of a table of guidance tools obtained by the guidance tool obtainment unit 220. Here, two kinds of guidance tools, that is, a guidance tool A and a guidance tool B, are managed in the table. The guidance tool A is a guidance tool that aims at causing an impression concerning English, and includes a video containing a message such as “The world is yours!” and a BGM for causing a favorable impression concerning English. The guidance tool B is a guidance tool that aims at prompting the start of English studying, and includes a video containing a message such as “English START!” or a voice of the message.

The guidance plan generating unit 241 generates a guidance plan (S102). The guidance plan may be generated by combining a plurality of the guidance tools.

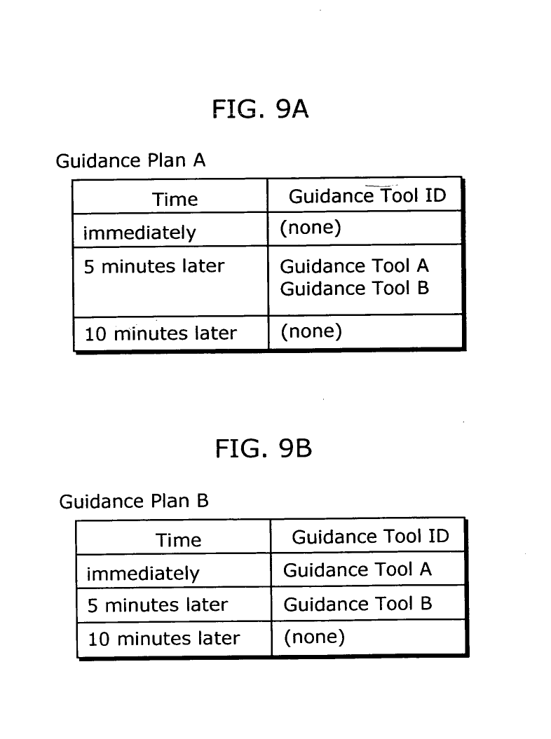

FIGS. 9A and 9B show examples of the guidance plan generated by the guidance plan generating unit 241. As shown in FIG. 9A, the guidance plan A is a plan of presenting both of the guidance tool A and the guidance tool B, 5 minutes after the generation of the guidance plan. In contrast, as shown in FIG. 9B, the guidance plan B is a plan of firstly presenting the guidance tool A immediately after, and then presenting the guidance tool B, 5 minutes later. Here, the “immediately after” means a timing of right after the generation of the guidance plan by the guidance plan generating unit 241.

The mental state reaction prediction unit 243 obtains a recognition result from the recognition unit 210 (S103). As described above, the recognition result includes a current status and a prediction of the external world situation, as well as a mental state and audio-visual information. In the following description, a current external world situation is assumed to have been obtained and the current external world situation is that the user currently in front of a station will get on a train in 5 minutes. The fact that the user is in front of the station can be determined, for example, on the basis of commuting route information inputted by the user in advance or alternatively position information obtained from the GPS mounted on the HMD. Further, a mental state is assumed to have been obtained and the mental state is that the current study willingness of the user is at level 0. The fact that the level of the study willingness is at 0 can be determined on the basis of the information that the user has not yet watched nor listened to information concerning English after the user waked up. Further, audio-visual information is assumed to have been obtained and t he audio-visual information indicates that no information is currently watched or listened by the user. The fact that no audio-visual information is currently watched or listened can be determined from the situation that the HMD is currently presenting no information.

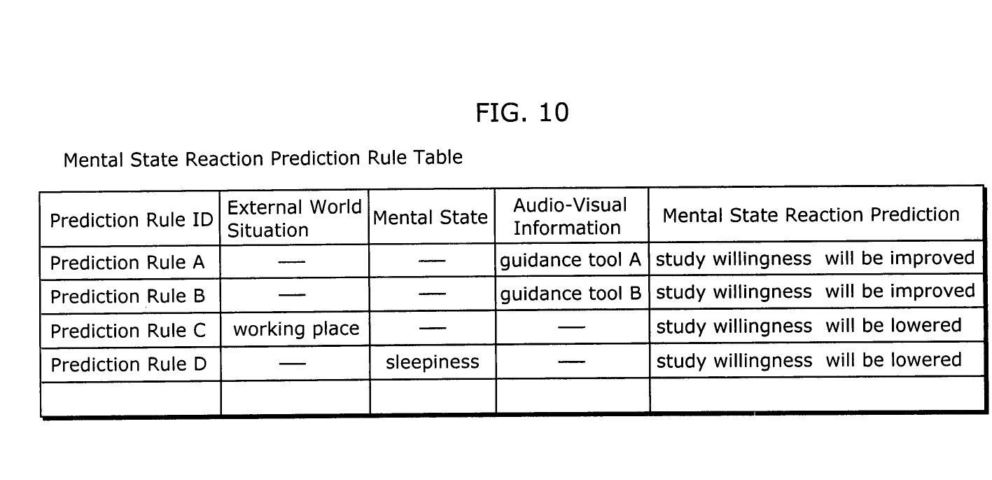

FIG. 10 is a table showing rules used in the mental state reaction prediction. In each rule, a mental state reaction caused in the user by an external world situation, a mental state, and audio-visual information is predicted, then the prediction result is defined as a rule. A prediction rule A defines that when the guidance tool A is presented to a user, the study willingness of the user will be improved. A prediction rule B defines that when the guidance tool B is presented to a user, the study willingness of the user will be improved. A prediction rule C defines that when the user is in a working place, the study willingness will be lowered. A prediction rule D defines that when the user feels sleepy, the study willingness will be lowered.

The mental state reaction prediction unit 243 generates a mental state prediction for each of the guidance plan A and the guidance plan B on the basis of the corresponding prediction rule and the recognition result obtained from the recognition unit 210 (S104).

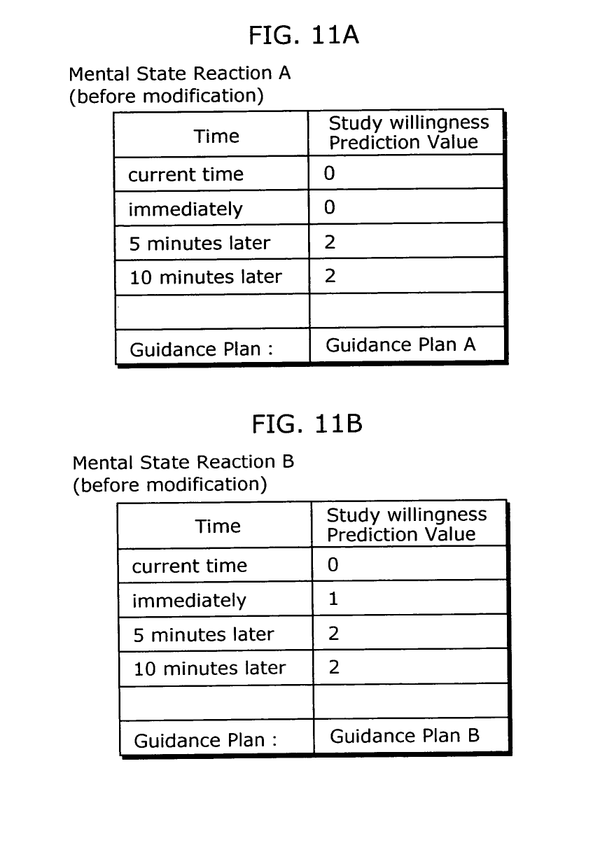

FIGS. 11A and 11B show examples of the mental state prediction.

FIG. 11A is a table showing a mental state prediction A (before modification) for the guidance plan A. FIG. 11A shows a state that a current study willingness prediction value is at level 0, the study willingness prediction value for immediately after is at level 0, the study willingness prediction value for 5 minutes later is at level 2, and the study willingness prediction value for 10 minutes later is at level 2. The current study willingness prediction value can be predicted on the basis of the recognition result obtained from the recognition unit 210. Since guidance is not started immediately after, the study willingness prediction value for immediately after is predicted to be at level 0. The guidance tool A and the guidance tool B are presented 5 minutes later. Thus, on the basis of the prediction rule A and the prediction rule B, the study willingness prediction value for 5 minutes later is predicted to be at level 2. In 10 minutes, no particular change arises. Thus, the study willingness prediction value for 10 minutes later is predicted also to be at level 2.

FIG. 11B is a table showing a mental state prediction B (before modification) for the guidance plan B. FIG. 11B shows a state that the current study willingness prediction value is at level 0, the study willingness prediction value for immediately after is at level 1, the study willingness prediction value for 5 minutes later is at level 2, and the study willingness prediction value for 10 minutes later is at level 2. The current study willingness prediction value can be predicted on the basis of the recognition result obtained from the recognition unit 210. Immediately after the guidance plan generation, the guidance tool A is presented. Thus, on the basis of the prediction rule A the study willingness prediction value for immediately after is predicted to be at level 1. The guidance tool B is presented 5 minutes later. Thus, on the basis of the prediction rule B, the study willingness prediction value for 5 minutes later is predicted to be at level 2. In 10 minutes, no particular change arises. Thus, the study willingness prediction value for 10 minutes later is predicted also to be at level 2.

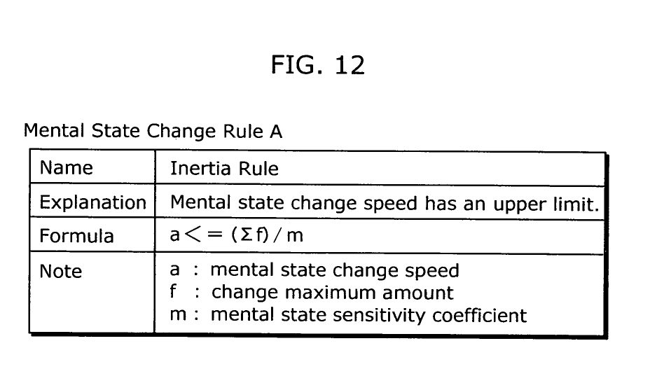

The mental state change rule application unit 245 obtains a mental state change rule from the mental state change rule obtainment unit 270 (S105). FIG. 12 is a table showing an inertia rule which is one of the mental state change rules. The inertia rule indicates that the mental state change speed has an upper limit, and thereby constrains an extremely rapid mental state change.

The mental state change rule application unit 245 applies the mental state change rule to the mental state prediction and thereby modifies the mental state prediction (S106). Specifically, the mental state change rule application unit 245 applies the inertia rule shown in FIG. 12 to each of the mental state prediction A and the mental state prediction B shown in FIGS. 11A and 11B, and thereby modifies the mental state prediction A and the mental state prediction B. A symbol f included in the formula of inertia rule denotes a maximum value (change maximum amount) within which each mental state change factor can change the mental state prediction value in a predetermined time period. Here, an amount of improvement of the study willingness achieved by the guidance tool A and an amount of improvement of the study willingness achieved by the guidance tool B are respectively 1. Thus, their total of 2 is adopted as the change maximum amount f. Further, a symbol m included in the formula denotes a coefficient indicating the difficultness of change of the mental state prediction value. Here, the study willingness for English is assumed to have a mental state sensitivity coefficient of 2. As a result, a constraint is obtained that the mental state change speed “a” included in the formula is smaller than or equal to 1.

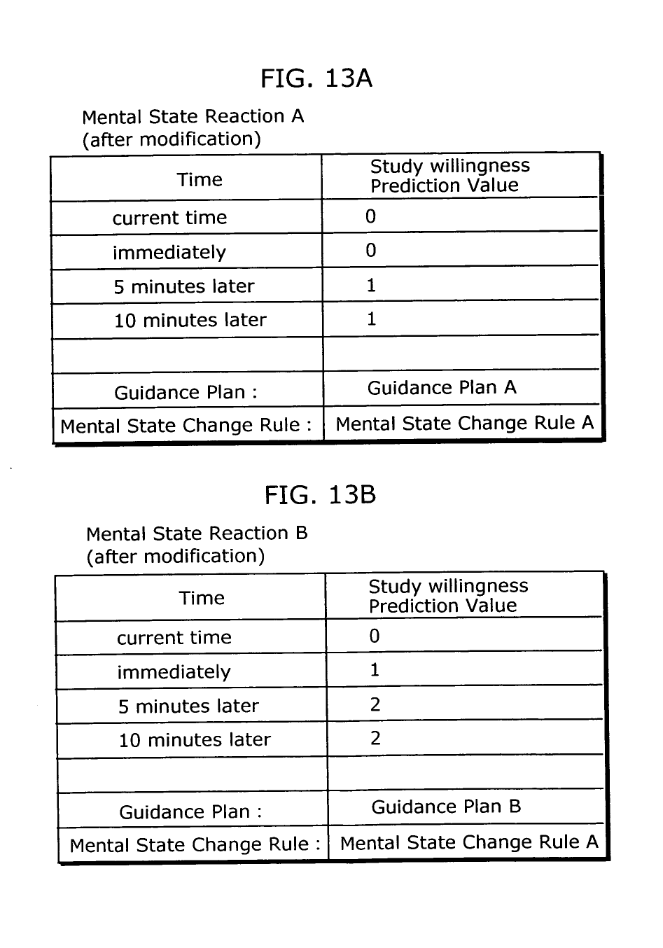

FIGS. 13A and 13B show the states after the mental state predictions are modified. That is, the constraint obtained as described above is applied to each of the mental state prediction A and the mental state prediction B shown in FIGS. 11A and 11B. Here, in spite of the constraint that the mental state change speed “a” is smaller than or equal to 1, the study willingness prediction value changes from 0 to 2 from immediately after to 5 minutes later in the mental state prediction A. Thus, the study willingness prediction value for 5 minutes later in the mental state prediction A is modified from 2 to 1. Further, in association with the modification from 2 to 1 in the study willingness prediction value for 5 minutes later, the study willingness prediction value for 10 minutes later is also modified from 2 to 1. On the other hand, the study willingness prediction value in the mental state prediction B is not modified since it changes by 1, from 0 to 1 and from 1 to 2.

The evaluation unit 246 evaluates the mental state predictions (S107). Here, the goal is set such that English studying willingness of the user during commuting should be improved. Thus, the study willingness prediction value is to be evaluated for 10 minutes later at which the user is expected to be on a train. That is, as shown in FIGS. 13A and 13B, since the study willingness prediction value for 10 minutes later in the mental state prediction A is 1, the evaluation value for the mental state prediction A becomes 1. On the other hand, since the study willingness prediction value for 10 minutes later in the mental state prediction B is 2, the evaluation value for the mental state prediction B becomes 2.

The guidance plan generating unit 241 determines whether another guidance plan should be generated (S108). Then, when having been determined as should be generated, the procedure goes to S102. In contrast, when having been determined as need not be generated, the procedure goes to S109. In this example, the two plans of the guidance plan A and the guidance plan B are generated, so that it is assumed that another guidance plan has been determined as need not be generated. However, it should be noted that the criterion for determining whether another guidance plan should be generated is not limited to the number of already existing guidance plans. For example, when no guidance plan has an evaluation value greater than or equal to 2, another guidance plan may be generated.

The guidance plan generating unit 241 compares the evaluation results (S109). In this example, the evaluation value for the mental state prediction A corresponding to the guidance plan A is 1, while the evaluation value for the mental state prediction B corresponding to the guidance plan B is 2. These values are compared with each other.

The guidance plan generating unit 241 selects a guidance plan having the highest evaluation (S110). In this example, the guidance plan B is selected as the guidance plan having the highest evaluation value.

Then, the guidance plan generating unit 241 gives the selected guidance plan to the guidance plan execution unit 250 (Sill). In this example, the guidance plan B is given to the guidance plan execution unit 250.

The guidance plan making processing is completed (S112).

As a result of the above-mentioned processing, the guidance plan B has been made. Accordingly, the guidance tool A is to be presented immediately after the guidance plan making processing, and then the guidance tool B is to be presented 5 minutes later. Thus, it is possible to guide the user in a planed and stepwise manner. That is, according to the first embodiment, a guidance plan consisting of a plurality of guidance tools can be made. Then, a mental state change in response to each of the guidance plans having been made is predicted so that these predictions are evaluated and compared with each other from the perspective of the guidance goal. Then, a guidance plan having the highest evaluation is executed. This permits guiding of the mental state of the user such that the English study willingness should be improved. Further, the inertia rule is applied on the mental state change prediction. This avoids extremely rapid and unpleasant guidance.

Here, whichever of the steps of S102 and S103 shown in FIG. 7 may be performed first. That is, what is necessary is that the steps S102 and S103 are completed before the step S104. Similarly, as for the step S104 and the step S105, whichever may be performed first. Further, the steps shown in FIG. 7 may be performed immediately one after another or alternatively with intermission. Alternatively, these steps may be performed in parallel.

Here, the mental state change rule shown in FIG. 12 is described by a formula. However, information other than the formula may be added in the mental state change rule. For example, information concerning a cartoon character, an agent, or the like may be added in order to explain the mental state change rule to the user. Alternatively, a purchasing amount, a utilization condition, or the like of the mental state change rule may be added.

Here, when generating the guidance plan, the guidance plan generating unit 241 may use information other than the guidance tool. For example, the guidance plan may be generated using the recognition result obtained from the recognition unit 210, a prediction obtained from the mental state change prediction unit 242, and the evaluation obtained from the evaluation unit 246. Similarly, the mental state change prediction unit 242 may perform prediction using the evaluation obtained from the evaluation unit 246. Further, the evaluation unit 246 may perform evaluation using the guidance plan obtained from the guidance plan generating unit 241 and the recognition result obtained from the recognition unit 210.

Here, the guidance plan generating unit 241 generates a guidance plan consisting of a plurality of guidance tools. The generation method is not limited to a particular one. That is, the guidance plan may be generated by a method of applying specific guidance tools into a template or alternatively by a method of reusing or combining all or part of other guidance plans. Further, the guidance plan may be generated by modifying or changing an original guidance plan.

Here, a single mental state change rule may be applied. Alternatively, a plurality of mental state change rules may be applied. Further, the user may designate which rule is to be applied. The system may be constructed such that in order that a rule should be applied, the user needs to purchase the rule. A rule to be applied may be determined automatically in accordance with the recognition result obtained from the recognition unit 210. The rule may be obtained automatically or alternatively in response to an instruction from the user. Modification, update, addition, deletion, and upload of the rule may also be performed automatically or alternatively in response to an instruction from the user.

### Second Embodiment

The second embodiment is described below for the processing that a guidance plan is made using a mental state change rule different from that of the first embodiment. Outlines of the block diagram and the processing are similar to those of the first embodiment. Thus, the following description is given with focusing attention mainly on their differences.

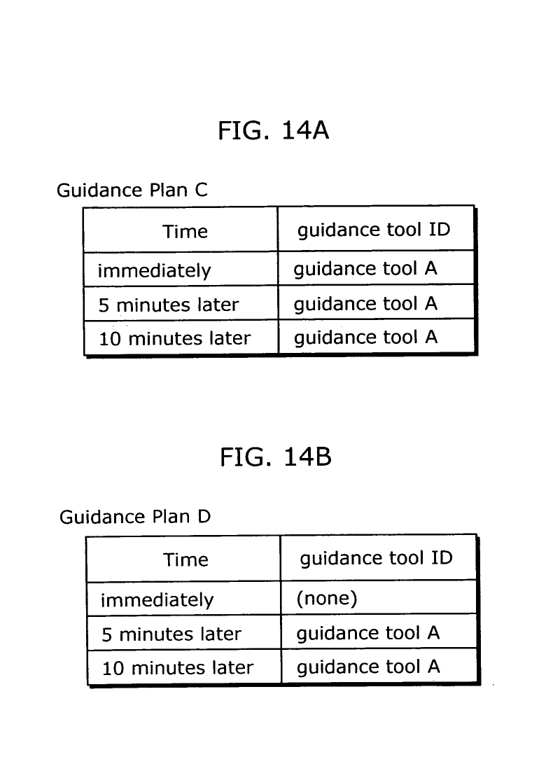

The guidance plan generating unit 241 combines two or more guidance tools and thereby generates a guidance plan (S102). FIGS. 14A and 14B show examples of guidance plans in the second embodiment. As shown in FIG. 14A, a guidance plan C is a plan of presenting the guidance tool A immediately after generating the guidance plan, 5 minutes later, and 10 minutes later. In contrast, as shown in FIG. 14B, a guidance plan D is a plan of presenting the guidance tool A, 5 minutes later and 10 minutes later. The mental state reaction prediction unit 243 generates a mental state prediction for each of the guidance plan C and the guidance plan D on the basis of the corresponding prediction rule and the recognition result obtained from the recognition unit 210 (S104).

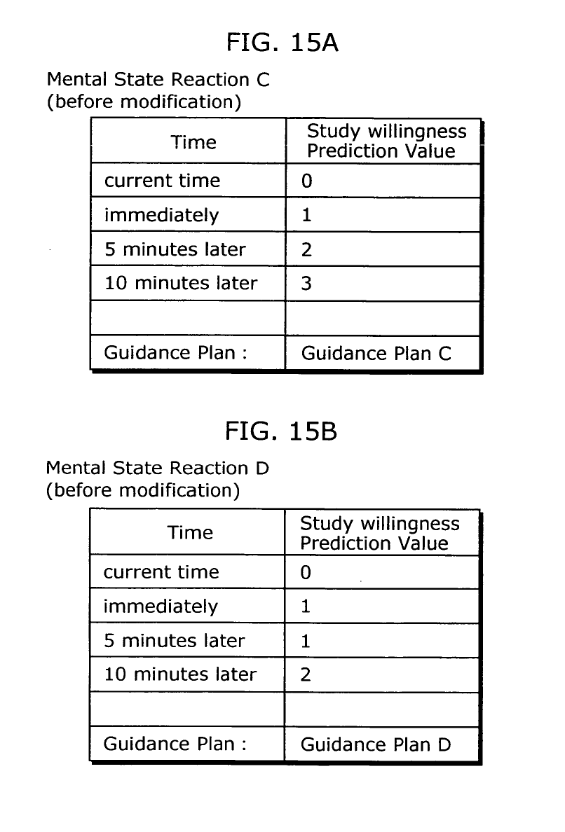

FIGS. 15A and 15B show examples of mental state predictions.

FIG. 15A is a table showing a mental state prediction C (before modification) for the guidance plan C. FIG. 15A shows a state that the current study willingness prediction value is at level 0, the study willingness prediction value for immediately after is at level 1, the study willingness prediction value for 5 minutes later is at level 2, and the study willingness prediction value for 10 minutes later is at level 3. The current study willingness prediction value can be predicted on the basis of the recognition result obtained from the recognition unit 210. Immediately after the guidance plan generation, the guidance tool A is presented. Thus, on the basis of the prediction rule A, the study willingness prediction value for immediately after is predicted to be at level 1. The guidance tool A is presented 5 minutes later also. Thus, on the basis of the prediction rule A, the study willingness prediction value for 5 minutes later is predicted to be at level 2. The guidance tool A is presented 10 minutes later also. Thus, on the basis of the prediction rule A, the study willingness prediction value for 10 minutes later is predicted to be at level 1.

FIG. 15B is a table showing a mental state prediction D (before modification) for the guidance plan D. FIG. 15B shows a state that the current study willingness prediction value is at level 0, the study willingness prediction value for immediately after is at level 0, the study willingness prediction value for 5 minutes later is at level 1, and the study willingness prediction value for 10 minutes later is at level 2. The current study willingness prediction value can be predicted on the basis of the recognition result obtained from the recognition unit 210. Since guidance is not started immediately after the generation of the guidance plan, the study willingness prediction value for immediately after is predicted to be at level 0. The guidance tool A is presented 5 minutes later. Thus, on the basis of the prediction rule A, the study willingness prediction value for 5 minutes later is predicted to be at level 1. The guidance tool A is presented 10 minutes later also. Thus, on the basis of the prediction rule A, the study willingness prediction value for 10 minutes later is predicted to be at level 2.

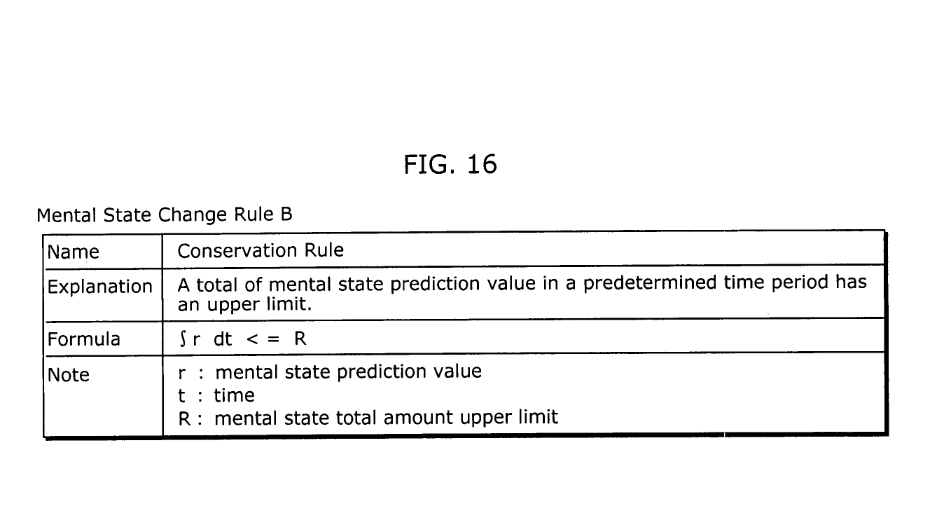

The mental state change rule application unit 245 obtains a mental state change rule from the mental state change rule obtainment unit 270 (S105). FIG. 16 is a table showing a conservation rule which is one of mental state change rules. The conservation rule indicates that an upper limit is present in the total of the mental state prediction values for a predetermined time period, and thereby constrains that a high prediction value continues.

The mental state change rule application unit 245 applies the mental state change rule to the mental state prediction and thereby modifies the mental state prediction (S106). Specifically, the mental state change rule application unit 245 applies the conservation rule shown in FIG. 16 to each of the mental state prediction C and the mental state prediction D shown in FIGS. 15A and 15B, and thereby modifies the mental state prediction C and the mental state prediction D. A symbol R included in the formula of conservation rule denotes an upper limit (mental state total amount upper limit) in the total of the mental state prediction values for a predetermined time period. Here, the mental state total amount upper limit for a period of 10 minutes is assumed to be 4. That is, the rule constrains that the total of the mental state prediction value for a period of 10 minutes exceeds the upper limit of 4.

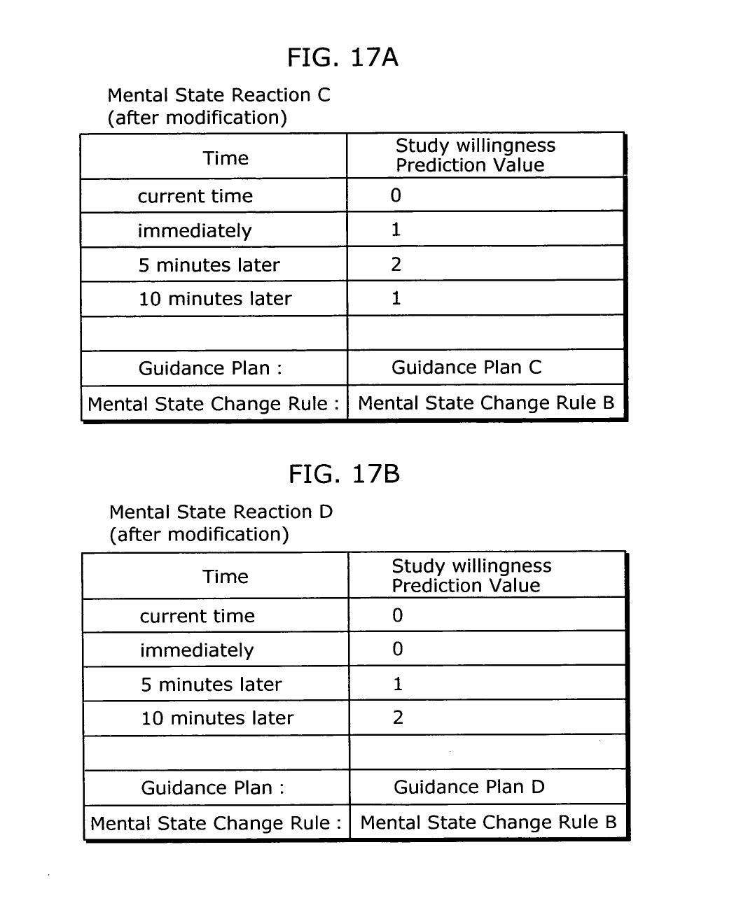

FIGS. 17A and 17B show the states after the mental state prediction is modified. That is, the constraint obtained as described above is applied to each of the mental state prediction C and the mental state prediction D shown in FIGS. 15A and 15B. Here, despite that the mental state total amount upper limit R for a period of 10 minutes is 4, the total of the study willingness prediction values from immediately after to 10 minutes later is 6 in the mental state prediction C. Thus, the study willingness prediction value for 10 minutes later in the mental state prediction C is modified from 3 to 1. On the other hand, in the mental state prediction D, the total of the study willingness prediction values from immediately after to 10 minutes later is 3. Thus, the study willingness prediction value is not modifies in the mental state prediction D.

The evaluation unit 246 evaluates the mental state predictions (S107). Here, the goal is set such that English studying willingness of the user during commuting should be improved. Thus, the study willingness prediction value is to be evaluated for 10 minutes later at which the user is expected to be on the train. That is, as shown in FIGS. 17A and 17B, since the study willingness prediction value for 10 minutes later in the mental state prediction C is 1, the evaluation value for the mental state prediction C becomes 1. On the other hand, since the study willingness prediction value for 10 minutes later in the mental state prediction D is 2, the evaluation value for the mental state prediction D becomes 2.

The guidance plan generating unit 241 compares the evaluation results (S109), thereby finds a guidance plan having the highest evaluation (S110), and then transmits the obtained guidance plan to the guidance plan execution unit 250 (S111). In this example, the guidance plan D is transmitted to the guidance plan execution unit 250.

The guidance plan making processing is completed (S112).

As a result of the above-mentioned processing, the guidance plan D has been made. Accordingly, guiding will not be performed immediately after, while the guidance tool A will be presented 5 minutes later and 10 minutes later. Further, according to the present second embodiment, a conservation rule is applied on the mental state change prediction. This avoids excessive guidance and hence permits appropriate guiding of the study willingness of the user.

### Third Embodiment

The third embodiment is described-below for the processing that a guidance plan is made using a mental state change rule different from those of the first and the second embodiments. Outlines of the block diagram and the processing are similar to those of the first embodiment. Thus, the following description is given with focusing attention mainly on their differences.

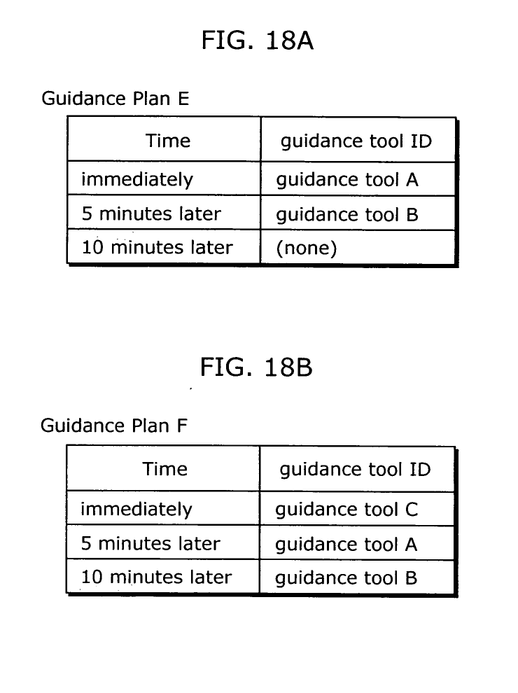

The guidance plan generating unit 241 combines two or more guidance tools and thereby generates a guidance plan (S102). FIGS. 18A and 18B show examples of guidance plans in the third embodiment. As shown in FIG. 18A, a guidance plan E is a plan of presenting the guidance tool A immediately after and then presenting the guidance tool B 5 minutes later. In contrast, as shown in FIG. 18B a guidance plan F is a plan of presenting the guidance tool C immediately after, then firstly presenting the guidance tool B, 5 minutes later, and then presenting the guidance tool A, 10 minutes later. The mental state reaction prediction unit 243 generates a mental state prediction for each of the guidance plan E and the guidance plan F on the basis of the corresponding prediction rule and the recognition result obtained from the recognition unit 210 (S104).

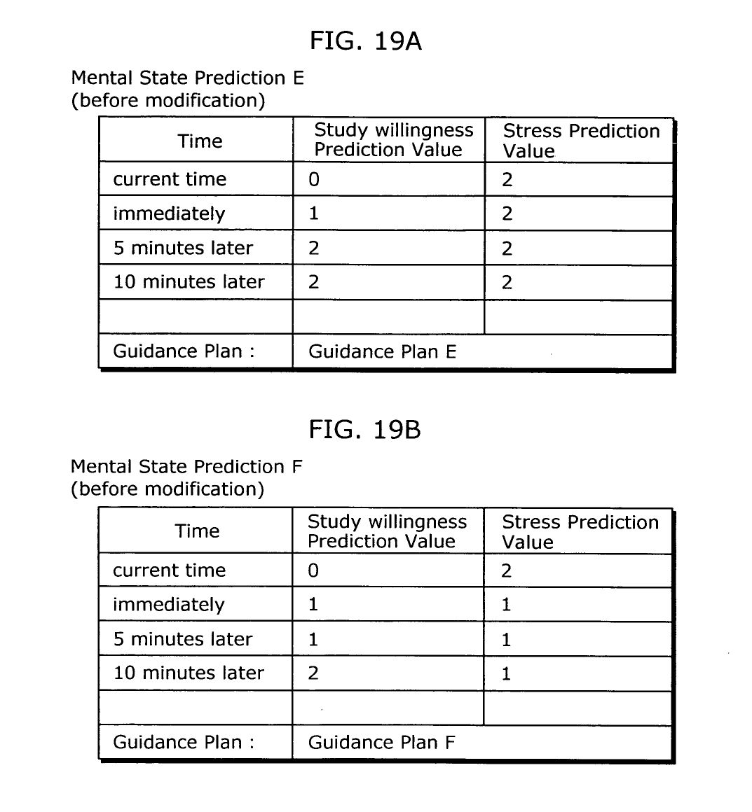

FIGS. 19A and 19B show examples of mental state predictions.

FIG. 19A is a table showing a mental state prediction E (before modification) for the guidance plan E. FIG. 19A shows a state that the current study willingness prediction value is at level 0, the study willingness prediction value for immediately after is at level 1, the study willingness prediction value for 5 minutes later is at level 2, and the study willingness prediction value for 10 minutes later is at level 2. The current study willingness prediction value can be predicted on the basis of the recognition result obtained from the recognition unit 210. Immediately after the guidance plan generation, the guidance tool A is presented. Thus, on the basis of the prediction rule A, the study willingness prediction value for immediately after is predicted to be at level 1. The guidance tool B is presented 5 minutes later. Thus, on the basis of the prediction rule B, the study willingness prediction value for 5 minutes later is predicted to be at level 2. In 10 minutes, no particular change arises. Thus, the study willingness prediction value for 10 minutes later is predicted also to be at level 2.

Further, the state is shown that the current stress prediction value is at level 2, the stress prediction value for immediately after is at level 2, the stress prediction value for 5 minutes later is at level 2, and the stress prediction value for 10 minutes later is at level 2. The current stress prediction value can be predicted on the basis of the recognition result obtained from the recognition unit 210. In this example, an increase in the stress is recognized that is caused by watching the news that a sport team supported by the user has lost a game, so that the current stress prediction value is predicted to be at level 2. No particular change arises immediately after, 5 minutes later, and 10 minutes later. That is, the stress prediction value is predicted to be at level 2.

FIG. 19B is a table showing a mental state prediction F (before modification) for the guidance plan F. FIG. 19B shows a state that the current study willingness prediction value is at level 0, the study willingness prediction value for immediately after is at level 0, the study willingness prediction value for 5 minutes later is at level 1, and the study willingness prediction value for 10 minutes later is at level 2. The current study willingness prediction value can be predicted on the basis of the recognition result obtained from the recognition unit 210. Immediately after the guidance plan generation, the guidance tool C is presented. Thus, on the basis of the prediction rule C, the study willingness prediction value for immediately after is predicted to be at level 0. The guidance tool A is presented 5 minutes later. Thus, on the basis of the prediction rule A, the study willingness prediction value for 5 minutes later is predicted to be at level 1. The guidance tool B is presented 10 minutes later. Thus, the study willingness prediction value for 10 minutes later is predicted to be at level 2.

Further, the state is shown that the current stress prediction value is at level 2, the stress prediction value for immediately after is at level 1, the stress prediction value for 5 minutes later is at level 1, and the stress prediction value for 10 minutes later is at level 1. Also in this example, a scene is assumed that an increase in the stress is expected to be caused by watching the news that a sport team supported by the user has lost a game. At immediately after, the guidance tool C is presented. Thus, with taking into consideration a reduction in the stress, the stress prediction value at immediately after is predicted to be at level 1. No particular change arises 5 minutes later and 10 minutes later. That is, the stress prediction value is predicted to be at level 1.

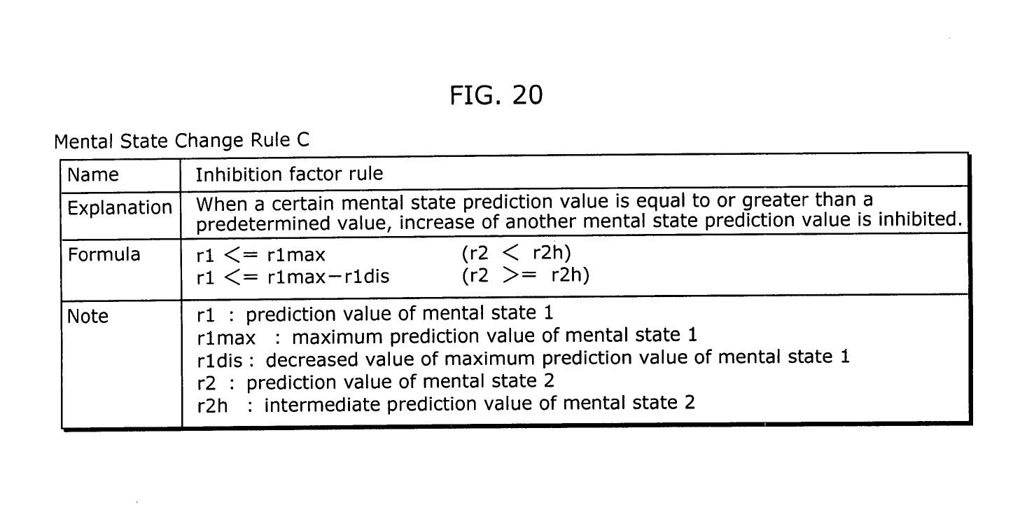

The mental state change rule application unit 245 obtains a mental state change rule from the mental state change rule obtainment unit 270 (S105). FIG. 20 is a table showing an inhibition factor rule which is one of mental state change rules. The inhibition factor rule indicates that when the mental state prediction value of a first mental state is at a predetermined value or greater, an increase is inhibited in the mental state prediction value of a second mental state. Thus, the inhibition factor rule constrains an increase in the mental state prediction value of the second mental state.

The mental state change rule application unit 245 applies the mental state change rule to the mental state prediction and thereby modifies the mental state prediction (S106). Specifically, the mental state change rule application unit 245 applies the inhibition factor rule shown in FIG. 20 to each of the mental state prediction E and the mental state prediction F shown in FIGS. 19A and 19B, and thereby modifies the mental state prediction E and the mental state prediction F. A symbol r1 included in the formula of inhibition factor rule denotes a prediction value of a mental state 1, and is hence a study willingness prediction value in this example. A symbol r1max included in the formula of inhibition factor rule denotes the maximum prediction value of the mental state 1, and is hence the study willingness maximum prediction value in this example. This maximum prediction value is assumed to be 2. A symbol r1dis included in the formula of inhibition factor rule denotes a decreased value of the maximum prediction value of the mental state 1, and is hence a decreased value of the maximum study willingness caused by a stress in this example. This decreased value is assumed to be 1. A symbol r2 included in the formula of inhibition factor rule denotes a prediction value of a mental state 2, and is hence a stress prediction value in this example. A symbol r2h included in the formula of inhibition factor rule denotes an intermediate prediction value of the mental state 2, and is hence a stress intermediate prediction value in this example. This intermediate prediction value is assumed to be 2. As a result, the study willingness prediction value is constrained from increasing from 1 to 2, when the stress prediction value is greater than or equal to 2.

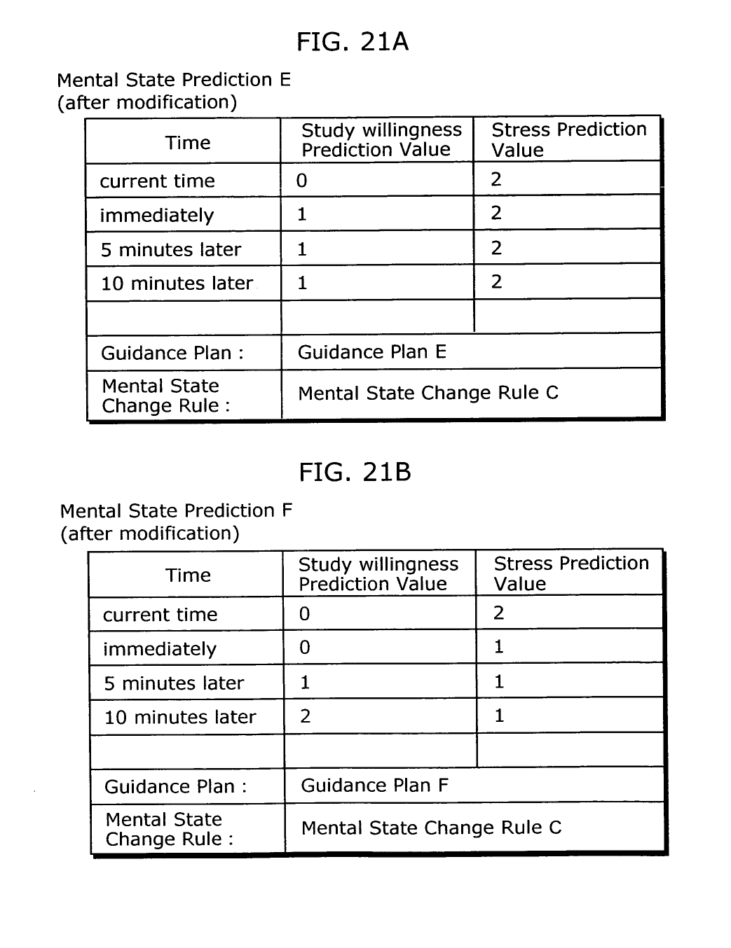

FIGS. 21A and 21B show the states after the mental state prediction is modified. That is, the constraint obtained as described above is applied to each of the mental state prediction E and the mental state prediction F shown in FIGS. 19A and 19B. Here, despite that the study willingness prediction value should be constrained from increasing from 1 to 2 when the stress prediction value is greater than or equal to 2, the study willingness prediction value in the mental state prediction E increases from 1 to 2 from immediately after to 5 minutes later. Thus, the study willingness prediction value for 5 minutes later is modified from 2 to 1. On the other hand, in the mental state prediction F, the stress prediction value continues to be 1 from the immediately after on. Thus, the study willingness prediction value is not modified.

The evaluation unit 246 evaluates the mental state predictions (S107). Here, the goal is set such that English studying willingness of the user during commuting should be improved. Thus, the study willingness prediction value is to be evaluated for 10 minutes later at which the user is expected to be on the train. That is, as shown in FIGS. 21A and 21B, since the study willingness prediction value for 10 minutes later in the mental state prediction E is 1, the evaluation value for the mental state prediction E becomes 1. On the other hand, since the study willingness prediction value for 10 minutes later in the mental state prediction F is 2, the evaluation value for the mental state prediction F becomes 2.

The guidance plan generating unit 241 compares the evaluation results (S109), thereby finds a guidance plan having the highest evaluation (S110), and then transmits the obtained guidance plan to the guidance plan execution unit 250 (S111). In this example, the guidance plan F is transmitted to the guidance plan execution unit 250.

The guidance plan making processing is completed (S112).

As a result of the above-mentioned processing, the guidance plan F has been made. As a result, the guidance tool C will be presented immediately after, then the guidance tool A will be presented 5 minutes, and then the guidance tool B will be presented 10 minutes later. Further, according to the present third embodiment, an inhibition factor rule is applied to the mental state change prediction. This permits removing of factors that could degrade the study willingness of the user, hence permits avoiding of useless guidance having no effect, and hence permits appropriate guiding of the study willingness of the user.

### Fourth Embodiment

In the first through the third embodiments, a configuration has been described that employs a mental state change rule in order to improve the quality of prediction when a mental state change of the user is predicted. In contrast, in the present fourth embodiment, a configuration is described that employs a mental state change rule in order to improve the quality of evaluation when a guidance plan is evaluated on the basis of the predicted mental state change.

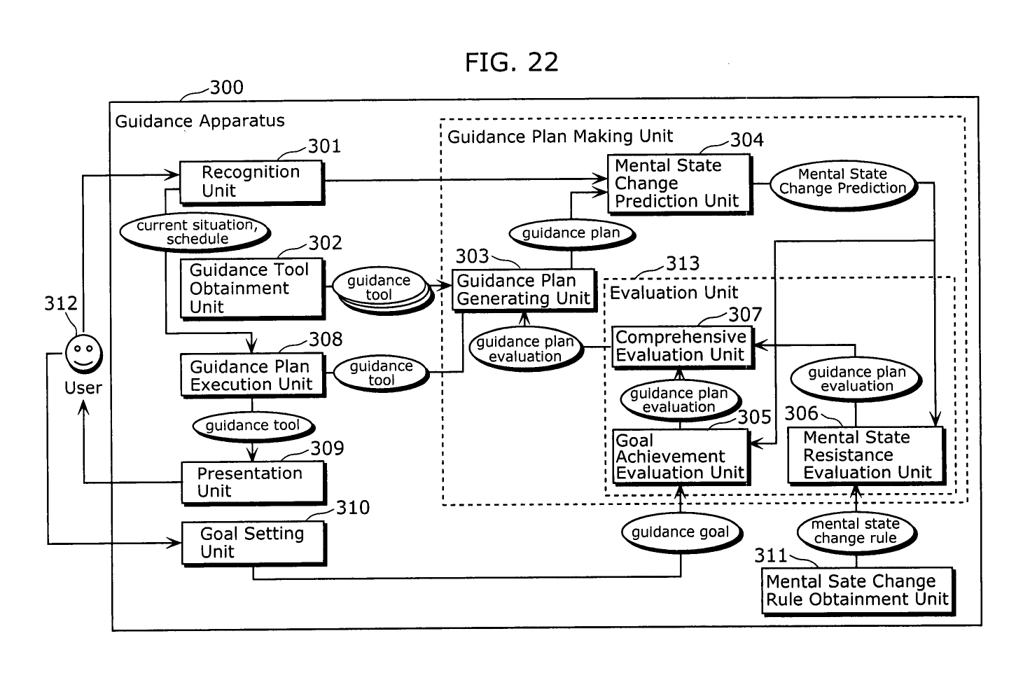

FIG. 22 is a block diagram of a whole guidance apparatus 300 according to the fourth embodiment of the present invention.

The guidance apparatus 300 is a device for guiding the mental state of a user. This guidance apparatus 300 functionally includes a recognition unit 301, a guidance tool obtainment unit 302, a guidance plan generating unit 303, a mental state change prediction unit 304, a goal achievement evaluation unit 305, a mental state resistance evaluation unit 306, a comprehensive evaluation unit 307, a guidance plan execution unit 308, a presentation unit 309, a goal setting and evaluation unit 310, and a mental state change rule obtainment unit 311.

The recognition unit 301 recognizes a situation of a user 312. The situation of the user 312 includes circumference information of the user 312, body information of the user 312, a behavior schedule of the user 312, and a mental state of the user 312. Means for recognizing the situation of the user 312 may be implemented in various manners and is not limited to a particular one. For example, when audio recognition and visual recognition technology is applied to a microphone, a camera, or the like mounted on a terminal (referred to as a “portable terminal”, hereinafter) carried by the user 312, circumference information of the user 312 can be obtained. Further, when information is read from wireless tags located around the user 312 through a wireless tag reader provided in the portable terminal, objects such as merchandise items located around the user 312 can be recognized. Further, when a biosensor mounted on the portable terminal is used, body information of the user 312 can be obtained like a heartbeat count, a sweat amount, or a body temperature change. Further, on the basis of the body information obtained in this way, information may be generated that expresses abstract mental state such as stress, concentration, or anxiety of the user. Further, a behavior schedule of the user 312 may be predicted or obtained from a schedule table, mails, or the like of the user 312 saved on the portable terminal or a server on a network. The acquisition method for the behavior history may be implemented in a various manner. For example, when a GPS mounted on the portable terminal is used, the movement history of the user 312 can be obtained. Further, when an electronic payment function such as Felica installed on the portable terminal is used, a merchandise purchasing history can be obtained. Further, behavior up to the current time point may be inferred from a schedule table, a to-do list, or the like saved on the portable terminal or a server on a network.

The guidance tool obtainment unit 302 obtains a guidance tool. The guidance tool is a means for changing the mental state of a user 312 and thereby guiding the mental state of the user 312, and includes an audio, a video, and a text message. For example, when healing music is reproduced in the portable terminal, the mental state of the user 312 can be guided such that the stress should be alleviated. The guidance tool employed may be a means generated by combining a video and a text, like a means of displaying on the HMD a cheering message from a cartoon character which is a favorite of the user 312. Further, in addition to information depending on visual and auditory senses such as an audio or a video, a vibration device, a fragrance device or the like may be employed for guiding the mental state of the user 312.

The guidance plan generating unit 303 generates a guidance plan including a plurality of guidance tools. Specifically, the guidance plan generating unit 303 selects a plurality of guidance tools from among the guidance tools obtained by the guidance tool obtainment unit 302, and then determines time periods (sequence) in which the selected guidance tools are to be executed for the user 312 as well as conditions to be satisfied at the time of execution. The following description is given with the assumption that the execution periods determined in this way and the execution conditions constitute a part of the guidance plan. The guidance plan may be a simple one in which an execution sequence among the guidance tools is set forth like “after healing music, a cheering message by a cartoon character is displayed”. Alternatively, in the guidance plan, a condition to be satisfied for the execution of each guidance tool may be set forth like “a cheering message by an cartoon character is displayed when the user arrives at a working place” (in this example, the condition is the situation of the user 312 of “arriving at a working place”). Obviously, both of the execution periods and the execution conditions may be set forth.

On the basis of the situation of the user 312 recognized by the recognition unit 301, the mental state change prediction unit 304 predicts a mental state change that would be caused in the user 312 when the guidance plan generated by the guidance plan generating unit 303 is executed. The mental state of the user 312 may be a mental state such as stress or concentration inferred from body information such as the pulse rate, the heartbeat count, or the sweat amount. Further, an advanced mental state such as “motivation” may be adopted that is inferred from a user model constructed on the basis of the behavior schedule and the behavior history of the user 312. The mental state change prediction unit 304 quantifies the change of the inferred mental state and thereby generates a mental state change prediction.

The method of predicting the mental state change is not limited to a particular one. For example, in a case that a particular guidance tool has been executed in the past, the prediction may be performed on the basis of the history of the mental state change at that time. Alternatively, a mental state change in response to a stimulus (such as a sound or a video) provided in each guidance tool may be predicted by a neural network, a Bayesian network, or the like.

On the basis of the mental state change prediction generated by the mental state change prediction unit 304, the evaluation unit 313 evaluates each guidance plan. The evaluation unit 313 comprises a goal achievement evaluation unit 305, a mental state resistance evaluation unit 306, and a comprehensive evaluation unit 307.

The goal achievement evaluation unit 305 evaluates the mental state change prediction generated by the mental state change prediction unit 304 from the perspective of the guidance goal. Evaluating the mental state change prediction is equal to evaluating the guidance goal corresponding to the mental state change prediction. The guidance goal indicates a goal that the user 312 desires to achieve using the guidance apparatus 300, like “becoming relaxed” or “striving for self-improvement”. The goal achievement evaluation unit 305 calculates as “an ideal mental state change” an ideal mental state change in accordance with the guidance goal, then compares the calculated ideal mental state change with the mental state change prediction generated by the lo mental state change prediction unit 304, and thereby evaluates the guidance plan. For example, in the case of a guidance goal of “becoming relaxed”, the goal achievement evaluation unit 305 calculates a low stress value as an ideal mental state change. Then, a low evaluation is imparted to a guidance plan that is predicted to cause a mental state change of high stress, while a high evaluation is imparted to a guidance plan that is predicted to cause a mental state change of low stress. Here, the guidance goal may be set by the user 312 oneself through the goal setting unit 310 described later, or alternatively may be retained as an initial value by the goal achievement evaluation unit 305. Further, the method of determining the ideal mental state change is not limited to a particular one. That is, a method may be adopted that the goal achievement evaluation unit 305 retains in advance a database that stores a value of preferable mental state corresponding to each set of a guidance goal of the user 312 and a situation of the user 312.

The mental state resistance evaluation unit 306 evaluates the mental state resistance caused by the mental state change predicted by the mental state change prediction unit 304. Evaluating the mental state resistance is equal to evaluating the guidance plan corresponding to the mental state resistance. The mental state resistance indicates unpleasant mental feeling or sense such as the feeling of discomfort, repulsion, or resistance caused by a change of the mental state of the user 312. Such mental state resistance arises, for example, when the mental state of the user 312 changes extremely rapidly (such as the case that stress increases extremely rapidly in the user 312). The mental state resistance evaluation unit 306 imparts a higher evaluation to a guidance tool that causes lower mental state resistance in the user 312. The method of evaluating the mental state resistance is not limited to a particular one. However, as described later, a mental state change rule is preferably employed that describes the characteristics of mental state change of the user 312.

On the basis of the result evaluated by the goal achievement evaluation unit 305 and the result evaluated by the mental state resistance evaluation unit 307, the comprehensive evaluation unit 307 generates a comprehensive evaluation value for the guidance plan.

On the basis of the situation of the user 312 recognized by the recognition unit 301, the guidance plan execution unit 308 successively executes the guidance tools included in the provided guidance plan.

The presentation unit 309 outputs to a device the result of execution of the guidance plan execution unit 308. The device to which the presentation unit 309 outputs the information is not limited to a particular one. That is, for example, an audio reproduction device in the portable terminal or alternatively a display for presenting a video or text information may be employed. Further, a device may be adopted that has the function of providing a stimulus such as heat, vibration, or fragrance to the five senses of the user 312. Further, the presentation unit 309 may communicate by wire or wireless with the device for outputting the information.

The goal setting and evaluation unit 310 sets a guidance goal in the guidance apparatus 300. The means for setting the guidance goal is not limited to a particular one. That is, a method employing a GUI for setting the goal or alternatively a method of audio input may be adopted.

The mental state change rule obtainment unit 311 obtains a mental state change rule. The mental state change rule is a rule used for inferring mental state resistance caused in the user 312 and deduced from the psychological and physiological point of view. This rule contains information used for predicting the mental load caused in the user 312, on the basis of the rate of change of the mental state change prediction or the like.

Here, the guidance apparatus 300 may be constructed on a terminal held by the user such as an HMD, a portable telephone, or a personal computer, or alternatively may be constructed on a server on a network. Further, in place of being constructed on a single terminal or a single server, the guidance apparatus 300 may be constructed by a plurality of terminals or servers.

The processing of the guidance apparatus 300 according to the present embodiment is described below. The guidance apparatus 300 guides the user 312 in a planed and stepwise manner by performing the following three procedures.

1. Generating a guidance plan

2. Executing the guidance plan

3. Setting a guidance goal

First, “1. Generating a guidance plan” is described below.

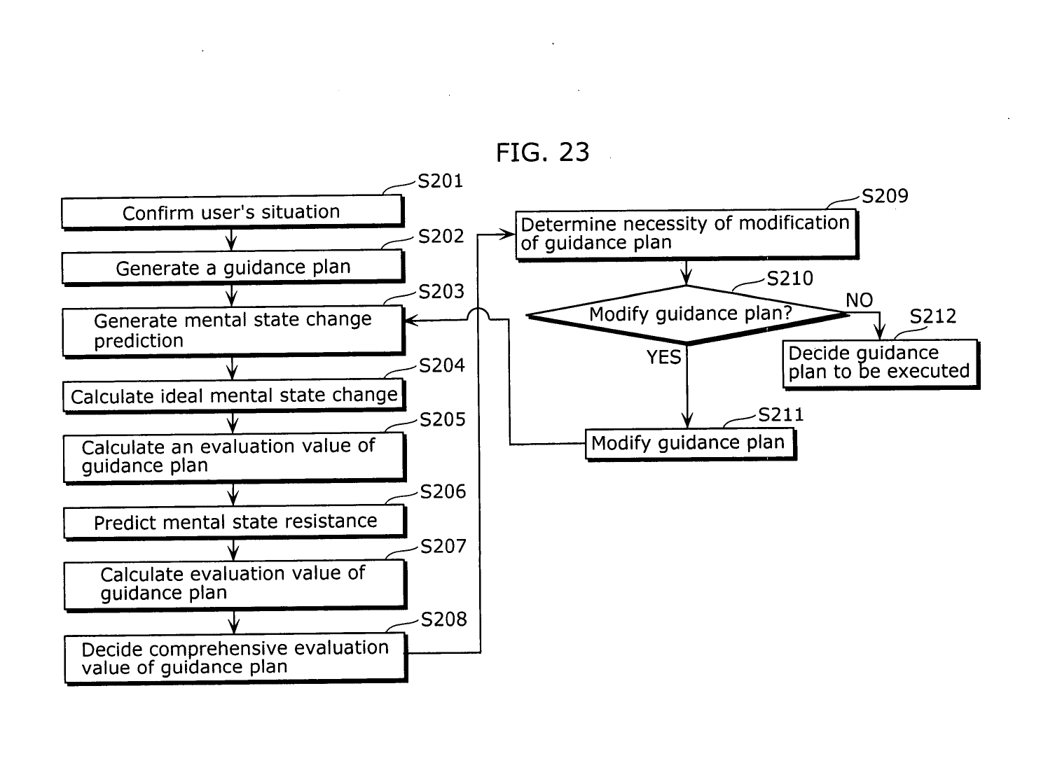

FIG. 23 is a flowchart showing processing for generating a guidance plan. The guidance apparatus according to the present embodiment executes Steps 201-212 and thereby generates a guidance plan.

[Step 201]

The recognition unit 301 recognizes the situation of the user 312 and then notifies the recognition result to the mental state change prediction unit 304. As described above, the situation of the user 312 includes the circumference information of the user 312, the body information of the user 312, the behavior schedule of the user 312, and the mental state of the user 312. The method of recognizing the situation of the user 312 is not limited to a particular one. However, in this example, the following method is adopted.

(1) Circumference Information of the User

The recognition unit 301 recognizes the current position of the user 312 by using a GPS mounted on the portable terminal. Further, when information is read from wireless tags located around the user 312 through a wireless tag reader provided in the portable terminal, objects such as merchandise items located around the user 312 are recognized.

(2) Behavior Schedule of the User

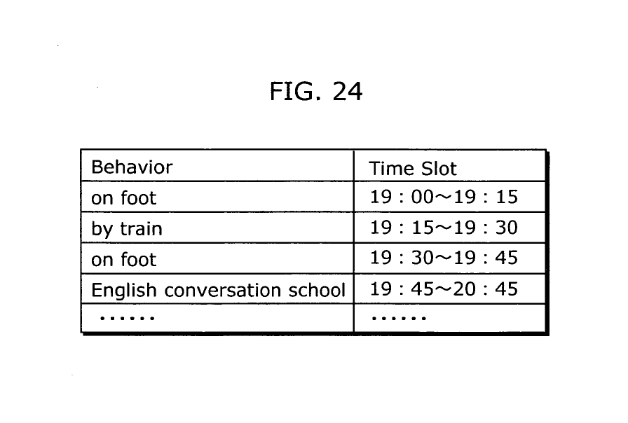

The recognition unit 301 obtains a behavior history and a behavior schedule table of the user 312 from the portable terminal, a server on a network, or the like, and then infers the behavior schedule of the user 312 on the basis of the current time. An example of the behavior schedule of the user 312 inferred in this way is shown in FIG. 24.

(3) Mental State of the User

Using various kinds of sensors, an eye camera, or the like provided in the portable terminal, the recognition unit 301 obtains body information of the user 312 such as the heartbeat count, the sweat amount, or the state of respiration and pupils. Then, on the basis of the obtained body information, the recognition unit 301 infers the current mental state of the user 312 such as stress, concentration, or behavior willingness. Here, the method of inferring the mental state of the user 312 on the basis of various kinds of body information is not limited to a particular one. A general method may be adopted.

(4) Audio-Visual Information of the User

The recognition unit 301 identifies a terminal currently used by the user 312, and then recognizes the information displayed on the identified terminal as the audio-visual information of the user 312.

[Step 202]

From the guidance tools obtained by the guidance tool obtainment unit 302, the guidance plan generating unit 303 generates a guidance plan for guiding the mental state of the user 312. Then, the guidance plan generating unit 303 notifies the generated guidance plan to the mental state change prediction unit 304.

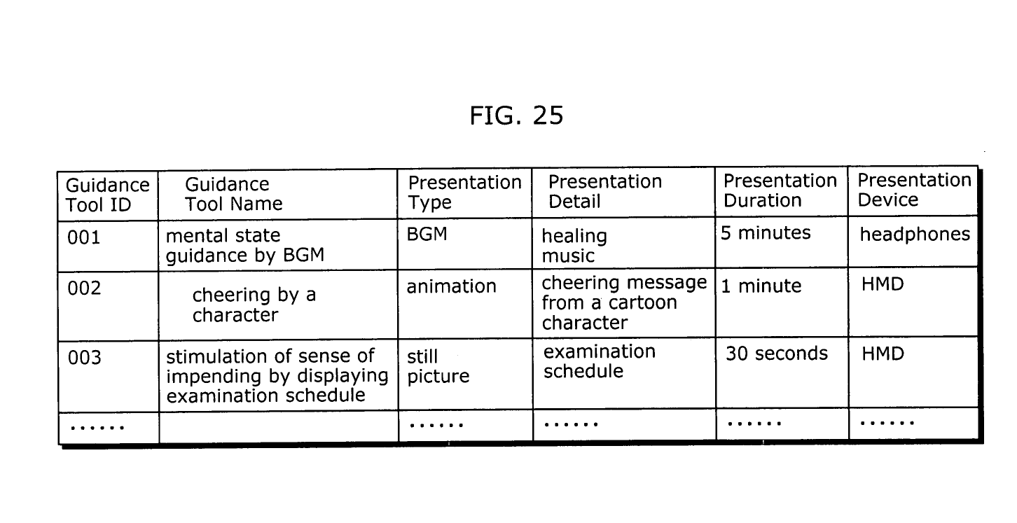

FIG. 25 shows an example of guidance tools obtained by the guidance tool obtainment unit 302. As shown in FIG. 25, each guidance tool is a method for presenting music, a video, or the like to the user 312. For example, the guidance tool having a guidance tool ID of “001” (referred to as “the guidance tool 1”, hereinafter) is a method for implementing the mental state guidance by BGM. Specifically, in this method, healing music is presented to the user 312 for 5 minutes through the headphones. Here, the information (BGM in this example) presented to the user 312 is also included in the guidance tool.

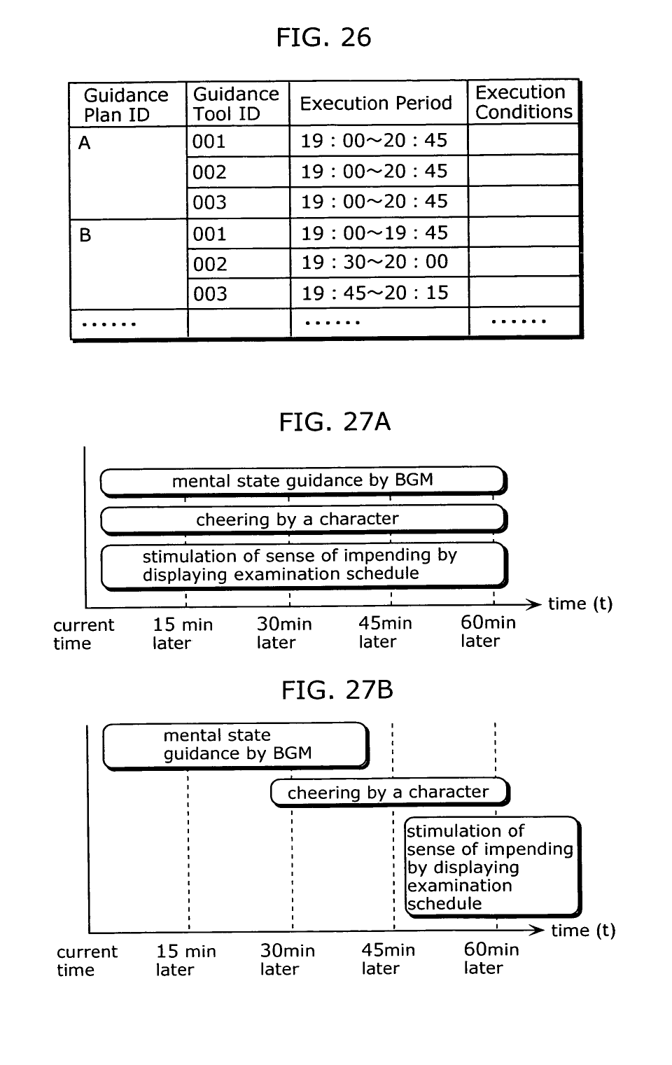

FIG. 26 shows an example of a guidance plan generated by the guidance plan generating unit 303. As shown in FIG. 26, the guidance plan includes the periods in which the guidance tools are to be executed as well as the conditions to be satisfied at the time of execution. The guidance plan A is a plan of executing the guidance tools 1-3 respectively from 19:00 to 20:45. The guidance plan B is a plan of executing the guidance tool 1 from 19:00 to 19:45, then executing the guidance tool 2 from 19:30 to 20:00, and then executing the guidance tool 3 from 19:45 to 20:15.

Here, in the example shown in FIG. 26, the periods in which the guidance tools are to be executed are determined. However, the present invention is not limited to this particular example. For example, in place of the periods in which the guidance tools are to be executed, a condition to be satisfied at the time of executing a guidance tool may be determined like “the guidance tool 1 is to be executed when the user arrives at the station”. In this case, a similar effect is achieved.

FIGS. 27A and 27B show the situations that the guidance plans are executed. That is, as shown in FIG. 27A, in the guidance plan A, a plurality of the guidance tools are executed simultaneously so that the mental state of the user 312 may be guided. Further, as shown in FIG. 27B, in the guidance plan B, guidance tools to be executed are switched successively so that the mental state of the user 312 may be guided.

[Step 203]

The mental state change prediction unit 304 predicts a mental state change that would be caused in the user 312 when the guidance plan generated by the guidance plan generating unit 303 is executed. The mental state includes various kinds of mental state such as concentration, stress, or behavior willingness which is owned by a person. However, the following description is given for the case of concentration.

First, the mental state change prediction unit 304 retains mental state influence data in advance. The mental state influence data is data indicating an influence to the mental state of the user 312 caused when each guidance tool is executed. The method of generating the mental state influence data is not limited to a particular one. However, when a guidance tool has already been executed, the data can be generated on the basis of a reaction history or the like of the user 312 having been caused at that time.

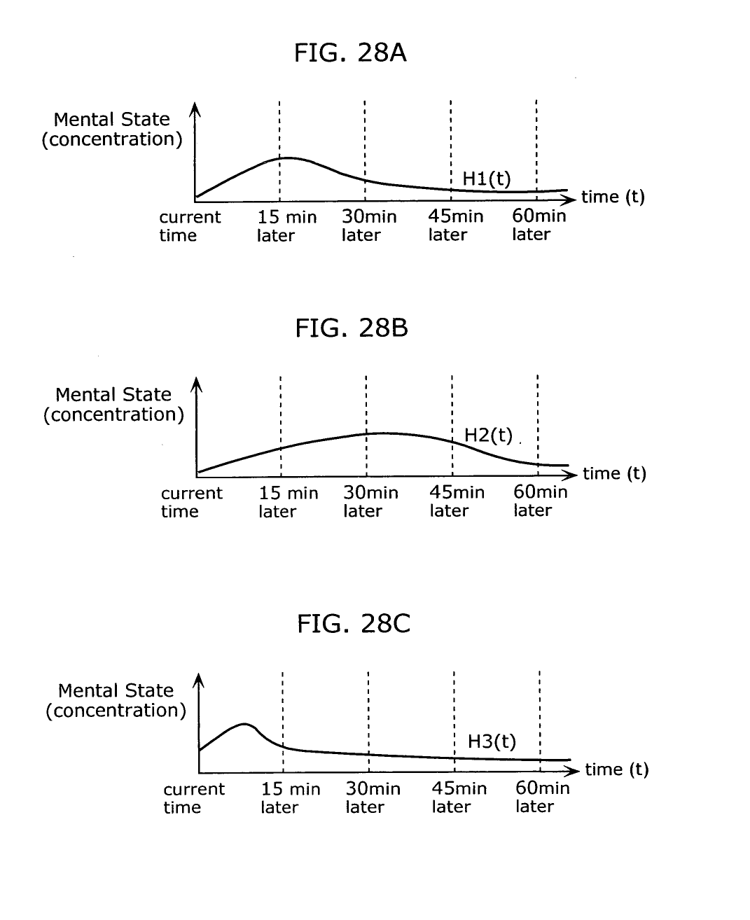

FIGS. 28A to 28C shows mental state influence data of each guidance tool retained by the mental state change prediction unit 304. FIG. 28A shows mental state influence data corresponding to the guidance tool 1. FIG. 28B shows mental state influence data corresponding to the guidance tool 2. FIG. 28C shows mental state influence data corresponding to the guidance tool 3. Each of the mental state influence data is a prediction value for the increase or decrease in the concentration of the user 312 caused when each guidance tool is executed. Each data is expressed as a function H1(t), H2(t), or H3(t) of time t.

Then, on the basis of the mental state influence data, the mental state change prediction unit 304 predicts a change of the mental state of the user 312 that would be caused when each guidance plan is executed. The mental state change prediction unit 304 then quantifies the prediction value, and thereby generates a mental state change prediction.

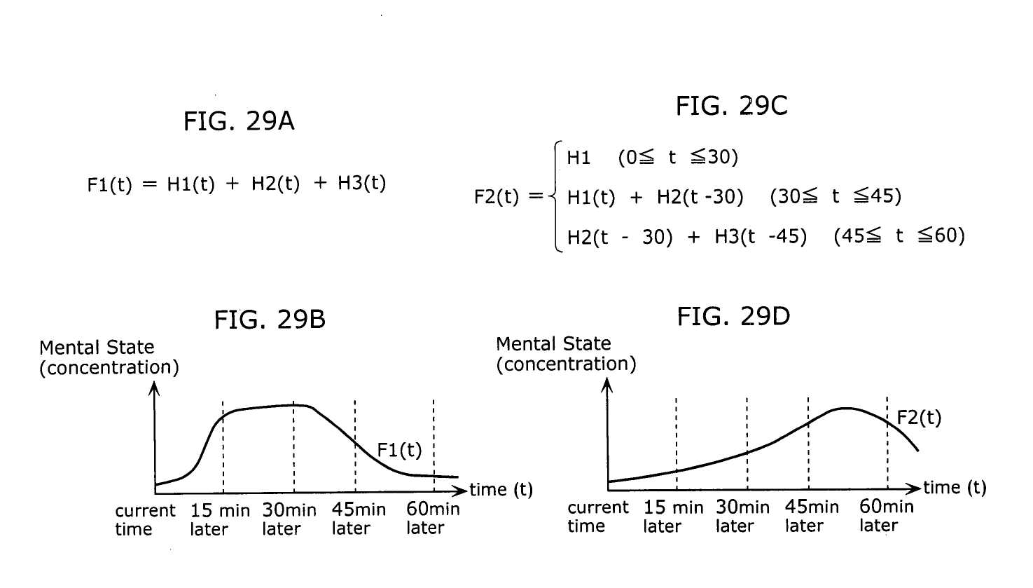

FIGS. 29A to 29D show examples of mental state change predictions.

In FIG. 29A, an increase or decrease in the concentration of the user 312 caused when the guidance plan A is executed is shown as a function F1(t) of time t. As shown in FIG. 27A, the guidance plan A is a plan of executing the guidance tools 1-3 simultaneously. Thus, the function F1(t) is expressed as the sum of the mental state influence data H1(t), H2(t), and H3(t) corresponding to the guidance tools 1-3. The function F1(t) is shown in FIG. 29B in the form of a graph.

In FIG. 29C, an increase or decrease in the concentration of the user 312 caused when the guidance plan B is executed is shown as a function F2(t) of time t. The guidance plan B is a plan in which guidance tools to be executed are switched successively. Thus, the function F2(t) is expressed by adding the mental state influence data H1(t), H2(t), and H3(t) corresponding to the guidance tools 1-3 over the corresponding execution periods. The function F2(t) is shown in FIG. 29D in the form of a graph.

At last, the mental state change prediction unit 304 notifies the mental state change predictions expressed as the functions F1(t) and F2(t) to the goal achievement evaluation unit 305 and the mental state resistance evaluation unit 306.

The method of predicting the mental state change described here is merely an example. That is, in place of the prediction method described here, the mental state change of the user 312 may be predicted using a neural network, a Bayesian network, or the like.

[Step 204]

In order to generate an evaluation value for each guidance plan, on the basis of the situation of the user 312 and the guidance goal, the goal achievement evaluation unit 305 calculates “the change of the ideal mental state for achieving the guidance goal”. The guidance goal is a goal that the user 312 desires to achieve using the guidance apparatus 300, like “English studying”, “work”, or “relaxation”.

The goal achievement evaluation unit 305 retains the guidance goal in the inside. Further, the goal achievement evaluation unit 305 retains information for calculating a preferable mental state for achieving each guidance goal. Thus, using this information, the goal achievement evaluation unit 305 infers the ideal mental state for the user 312 achieving the goal.

FIG. 30 shows an example of an ideal mental state value table. The ideal mental state value table is a table indicating what kind of mental state is preferable in what kind of situation (a place and a time slot) for achieving the guidance goal. Specifically, the table retains a preferable value (an ideal value) for the mental state in correspondence to each set of a guidance goal and a situation of the user 312. FIG. 30 shows the case that the guidance goal is “English studying”. In this case, the user 312 on “the train” is in a situation suitable for studying English. Thus, it is preferable that the user 312 retain high concentration. On the other hand, the user 312 moving “on foot” is in a situation not suitable for studying English. Thus, the user 312 is not required to retain high concentration.

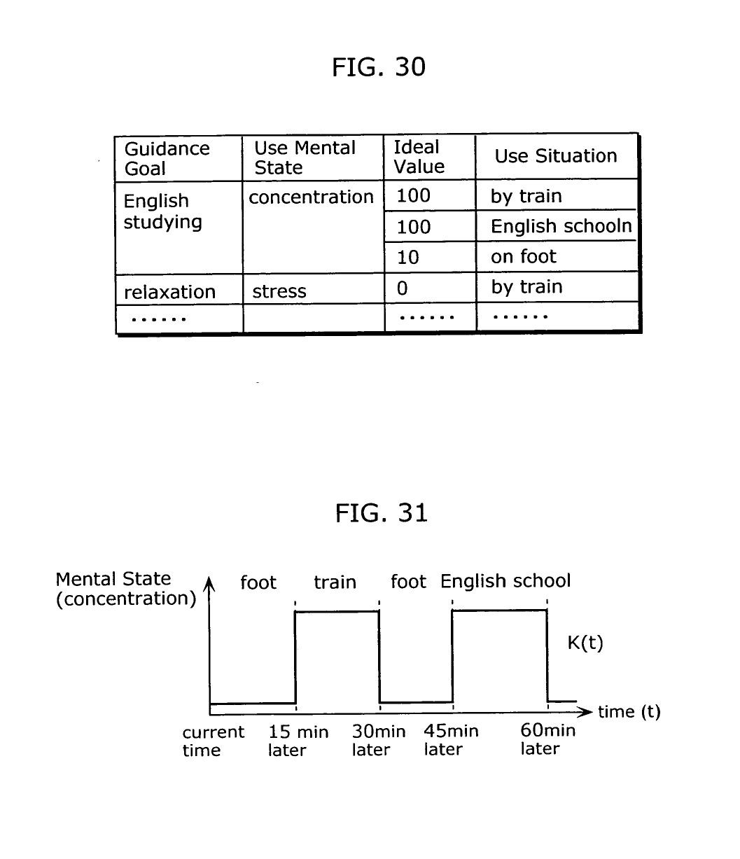

FIG. 31 shows an example of an ideal mental state change generated by the goal achievement evaluation unit 305. That is, on the basis of the behavior schedule of the user 312 and the ideal mental state value table, the goal achievement evaluation unit 305 generates as the ideal mental state change a change of the mental state that matches best with the guidance goal.

[Step 205]

The goal achievement evaluation unit 305 compares the mental state change generated by the mental state change prediction unit 304 with the ideal mental state change generated at the above-mentioned Step 205, and thereby calculates an evaluation value for each guidance plan. Here, a higher evaluation is imparted to a guidance plan that has a mental state change prediction closer to the ideal mental state change.

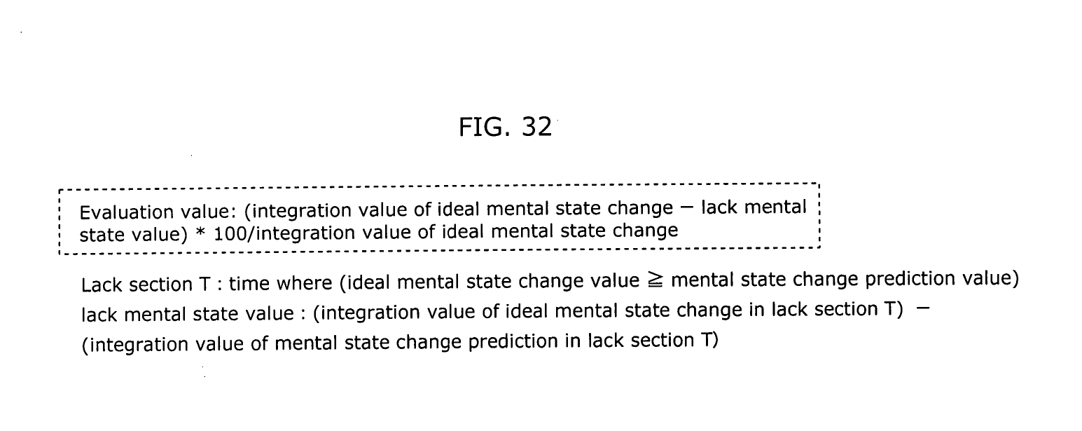

FIG. 32 shows a formula used when the goal achievement evaluation unit 305 calculates the evaluation value. A lack section T indicates a section in a time axis direction where the value of ideal mental state change K(t) exceeds the value of mental state change prediction F(t). Further, a lack mental state value indicates a value obtained by subtracting the integration value of the mental state change prediction F(t) in the lack section T from the integration value of the ideal mental state change K(t) in the lack section T. The evaluation value for the guidance plan increases with decreasing lack mental state value.

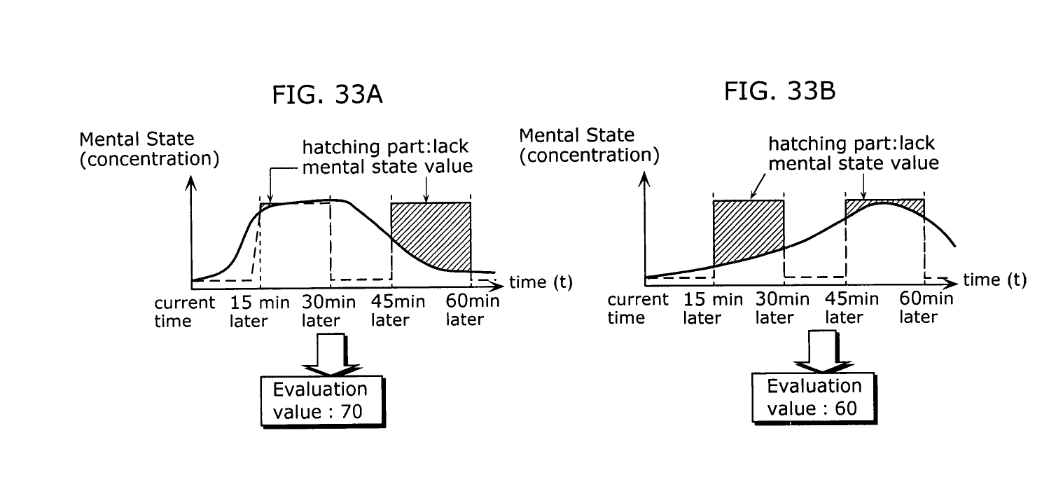

FIG. 33A shows a detailed example of a lack mental state value corresponding to the guidance plan A. FIG. 33B shows a detailed example of a lack mental state value corresponding to the guidance plan B. Each hacked part shown in these figures corresponds to the lack mental state value. The lack mental state value corresponding to the guidance plan A is smaller than the lack mental state value corresponding to the guidance plan B. Thus, the evaluation value for the guidance plan A becomes higher than the evaluation value for the guidance plan B. In this example, according to the formula shown in FIG. 32, an evaluation value of 70 is imparted to the guidance plan A, while an evaluation value of 60 is imparted to the guidance plan B.

The goal achievement evaluation unit 305 notifies the generated evaluation values to the comprehensive evaluation unit 307.

[Step 206]

The mental state resistance evaluation unit 306 predicts the mental state resistance such as the feeling of discomfort, resistance, or repulsion that would be caused in the user 312 when the guidance plan is executed. Here, a mental state change rule described later is applied to the mental state change prediction so that the mental state resistance caused in the user 312 is predicted.

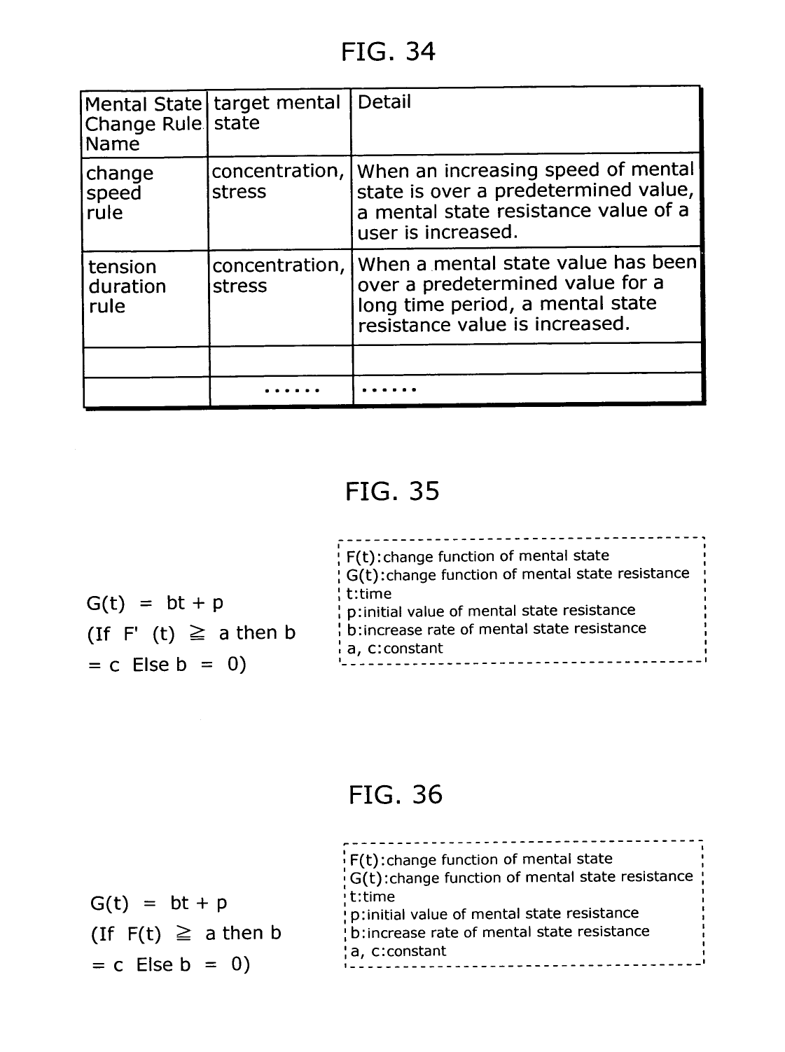

FIG. 34 is a table showing examples of mental state change rules. FIG. 34 shows two mental state change rules, that is, a change speed rule and a tension duration rule. The change speed rule is a rule indicating that the mental state resistance of the user 312 increases during the time that concentration or stress increases at a rate exceeding a predetermined speed. The tension duration rule is a rule indicating that mental state resistance arises in the user 312 when the value of concentration or stress exceeds a predetermined value. The mental state change rule obtainment unit 311 manages a large number of such mental state change rules and provides these mental state change rules to the mental state resistance evaluation unit 304 when necessary.

Similarly to the mental state change prediction, the mental state resistance of the user 312 is expressed as a function of time t. When this function of time t is denoted by G(t), each mental state change rule shown in FIG. 34 is expressed as a rule concerning the change of the function G(t).

FIG. 35 shows the change speed rule expressed by a formula. This formula indicates that in sections where the differential value of the function F(t) expressing the mental state change prediction of a particular guidance plan exceeds a predetermined value “a”, the function G(t) increases at a predetermined rate c, while in the other sections, the function G(t) does not increase. Similarly, FIG. 36 shows, in the form of a formula, the subject matter of the tension duration rule shown in FIG. 34. On the basis of these formulas and the mental state change predictions, the mental state resistance prediction unit 306 predicts the mental state resistance caused in the user 312 when each guidance plan is executed.

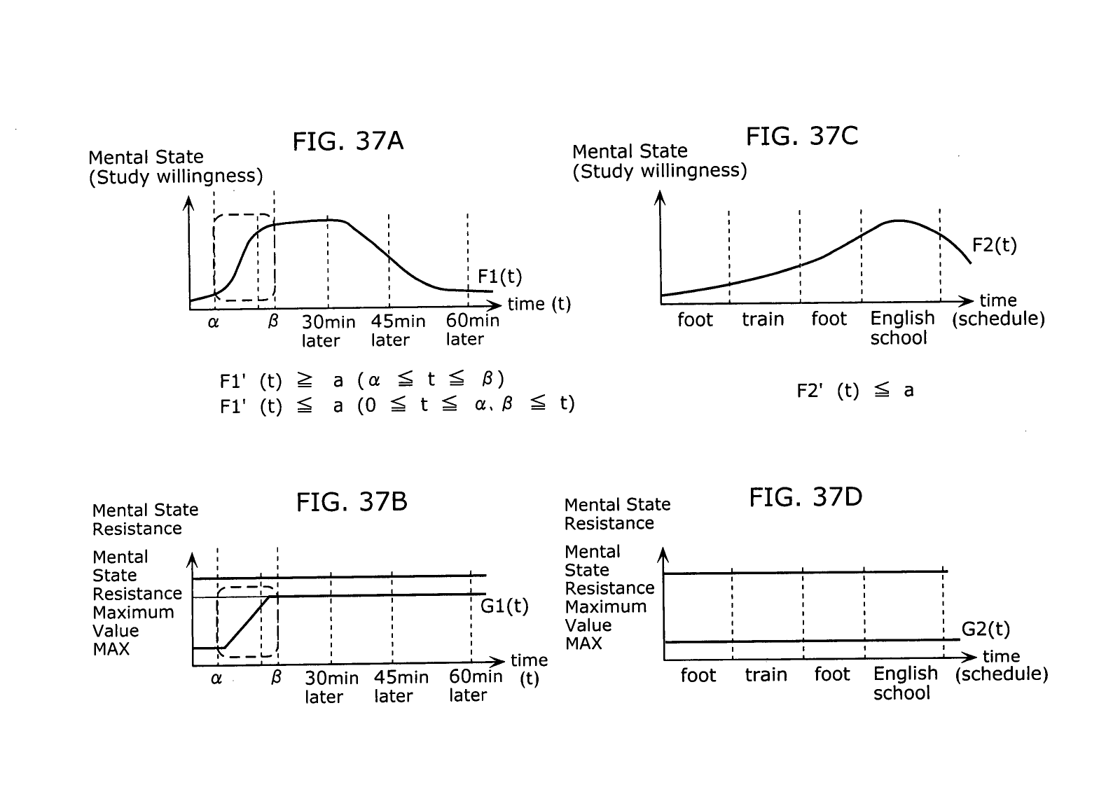

FIGS. 37A to 37D show examples of mental state resistance predictions based on the change speed rule.

FIG. 37A shows a mental state change prediction F1(t) that would be caused in the user 312 by the guidance plan A. The section specified by a broken line in FIG. 37A indicates a section where the differential value F1′(t) of F1(t) exceeds the value of a constant “a”. Thus, as shown in FIG. 37B, in the section specified by the broken line (a≦t≦β), the mental state resistance G1(t) of the user 312 increases at a ratio of a constant c in accordance with the change speed rule shown in FIG. 34.

FIG. 37C shows a mental state change prediction F2(t) that would be caused in the user 312 by the guidance plan B. Here, F2′(t)≦a holds always. Thus, as shown in FIG. 37D, the mental state resistance G2(t) caused in the user 312 when the guidance plan B is executed is predicted as not increasing but remaining at an initial value p.

Here, in a case that evaluation based on a particular mental state change rule cannot be performed like in a case that F(t) is undifferentiable, an evaluation value based on the mental state change rule is not generated. In this example, in a case that F(t) is undifferentiable, the mental state resistance is predicted not on the basis of the change speed rule shown in FIG. 35 but on the basis of the tension duration rule shown in FIG. 36.

[Step 207]

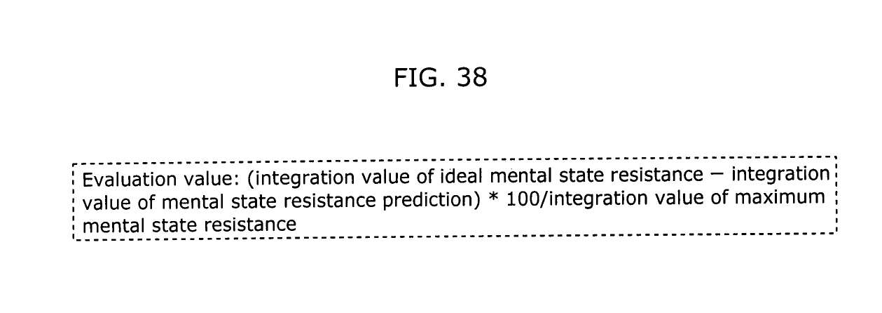

On the basis of the prediction value for the mental state resistance generated at the above-mentioned Step 206, the mental state resistance evaluation unit 306 calculates an evaluation value for each guidance plan. Here, it is determined that a smaller integration value of the prediction value G(t) for the mental state resistance for each guidance plan causes smaller mental state resistance in the user 312. Specifically, on the basis of the formula shown in FIG. 38, an evaluation value is determined for each guidance plan. The maximum mental state resistance indicates the maximum value that can be realized by the prediction value G(t) of the mental state resistance of the user 312. According to the formula shown in FIG. 38, a higher evaluation value is obtained for a guidance plan having a smaller integration value of the prediction value G(t).

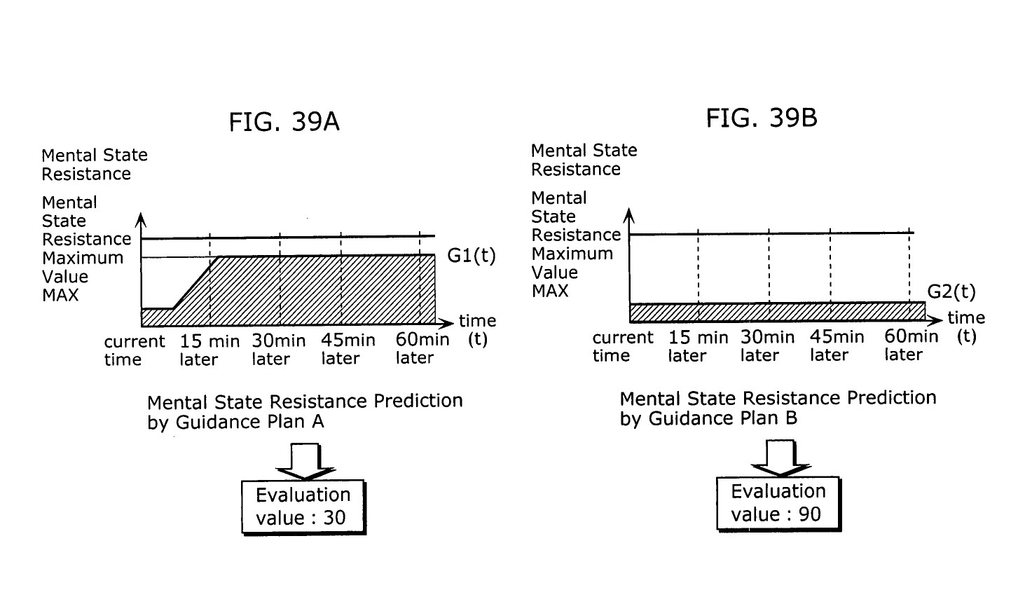

FIG. 39A shows the result of evaluation of the guidance plan A. FIG. 39B shows the result of evaluation of the guidance plan B. Each hacked part indicates the integration value of the prediction value G1(t) or G2(t) of the mental state resistance caused by each guidance plan. A smaller area of the hacked part indicates a higher evaluation value imparted to each guidance plan. Here, an evaluation value of 30 is imparted to the guidance plan A, while an evaluation value of 90 is imparted to the guidance plan B.

The mental state resistance evaluation unit 306 notifies the generated evaluation values to the comprehensive evaluation unit 307.

[Step 208]

On the basis of the evaluation value received from the goal achievement evaluation unit 305 and the evaluation value received from the mental state resistance evaluation unit 306, the comprehensive evaluation unit 307 determines a comprehensive evaluation value for each guidance plan.

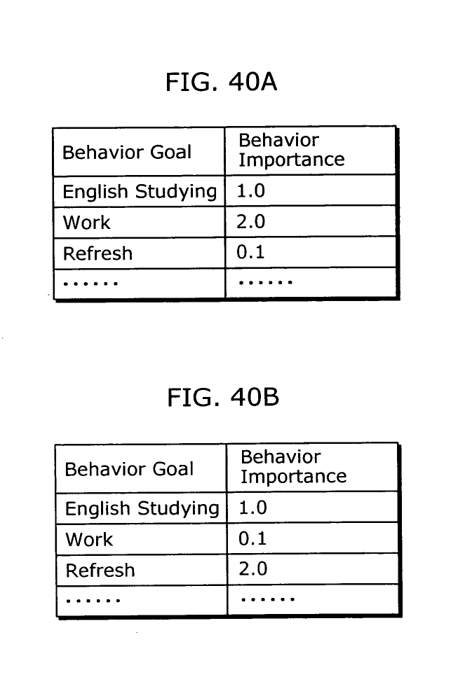

FIGS. 40A and 40B show importance degree determination tables. Specifically, FIG. 40A is a table for determining a weighting coefficient for the evaluation value obtained by the goal achievement evaluation unit 305. FIG. 40B is a table for determining a weighting coefficient for the evaluation value obtained by the mental state resistance evaluation unit 306.

Using the importance degree determination table, the comprehensive evaluation unit 307 calculates a comprehensive evaluation value for each guidance plan. That is, the comprehensive evaluation unit 307 determines a weighting coefficient to be multiplied onto each evaluation value in accordance with the guidance goal, and then adopts as a comprehensive evaluation value the value obtained by adding the results of multiplying each evaluation value by the determined weighting coefficient.

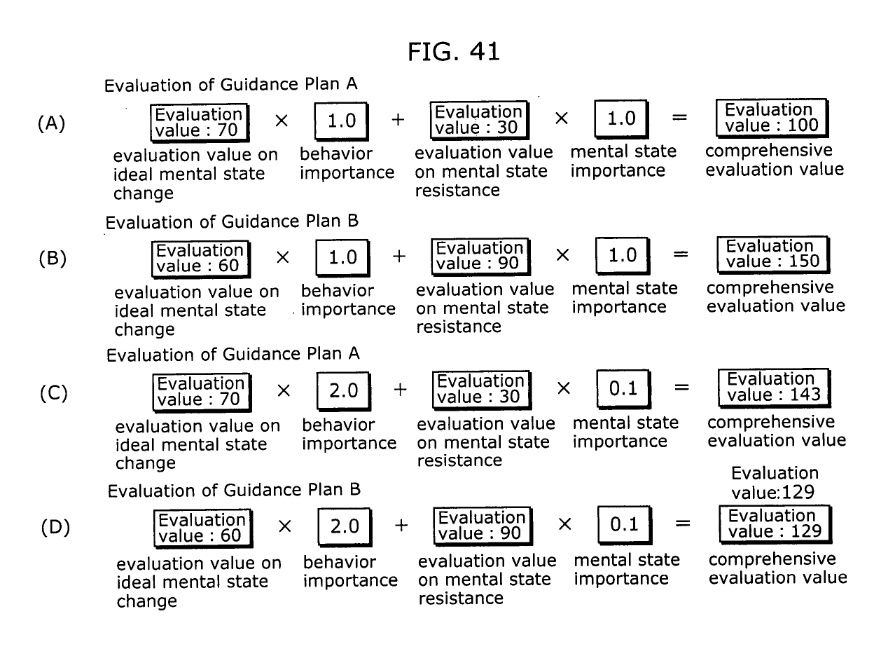

FIG. 41A is a diagram showing an example of calculation of the comprehensive evaluation value for the guidance tool A in the case that the guidance goal is “English studying”. FIG. 41B is a diagram showing an example of calculation of the comprehensive evaluation value for the guidance tool B in the case that the guidance goal is “English studying”.

As shown in FIG. 40A, the factor for the evaluation value obtained by the goal achievement evaluation unit 305 is 1. Further, as shown in FIG. 40B, the factor for the evaluation value obtained by the mental state resistance evaluation unit 306 is also 1. Thus, as shown in FIG. 41A, the comprehensive evaluation value for the guidance plan A becomes a value of 100 which is the total of the evaluation value based on the ideal mental state change of 70 multiplied by 1 and the evaluation value based on the mental state resistance of 30 multiplied by 1. On the other hand, as shown in FIG. 41B, the comprehensive evaluation value for the guidance plan B becomes a value of 150 which is the total of the evaluation value based on the ideal mental state change of 60 multiplied by 1 and the evaluation value based on the mental state resistance of 90 multiplied by 1. In this case, the guidance plan B has the higher evaluation value than the guidance plan A and is hence determined as being the better guidance tool.

FIG. 41C is a diagram showing an example of calculation of the comprehensive evaluation value for the guidance tool A in the case that the guidance goal is “work”. FIG. 41D is a diagram showing an example of calculation of the comprehensive evaluation value for the guidance tool B in the case that the guidance goal is “work”.

As shown in FIG. 40A, the factor for the evaluation value obtained by the goal achievement evaluation unit 305 is 2. Further, as shown in FIG. 40B, the factor for the evaluation value obtained by the mental state resistance evaluation unit 306 is 0.1. Thus, as shown in FIG. 41C, the comprehensive evaluation value for the guidance plan A becomes a value of 143 which is the total of the evaluation value based on the ideal mental state change of 70 multiplied by 2 and the evaluation value based on the mental state resistance of 30 multiplied by 0.1. On the other hand, as shown in FIG. 41D, the comprehensive evaluation value for the guidance plan B becomes a value of 129 which is the total of the evaluation value based on the ideal mental state change of 60 multiplied by 2 and the evaluation value based on the mental state resistance of 90 multiplied by 0.1. In this case, the guidance plan A has the higher evaluation value than the guidance plan B and is hence determined as being the better guidance tool.

The comprehensive evaluation unit 307 notifies the generated comprehensive evaluation values to the guidance plan generating unit 303.

[Step 209]

On the basis of the evaluation values notified from the comprehensive evaluation unit 307, the guidance plan generating unit 303 determines the necessity or non-necessity of modification for each guidance plan. The method of determining the necessity or non-necessity of modification is not limited to a particular one. However, preferably, a guidance plan having a comprehensive evaluation value below 50 is modified. This allows a guidance plan having a quality better than a predetermined criterion to be solely provided to the user. Here, when the comprehensive evaluation value is below 50, in place of modifying the guidance plan, another guidance plan may newly be generated.

[Step 210]

When the guidance plan is to be modified, the processing of Step 211 is executed.

When the guidance plan is not to be modified, the processing of Step 212 is executed.

[Step 211]

The guidance plan generating unit 303 modifies a guidance plan determined as requiring modification. Specifically, the guidance plan generating unit 303 changes the guidance tools to be executed or alternatively changes the execution periods or the execution conditions. The guidance plan after the modification is notified to the mental state change prediction unit 304 (to Step 203). Then, similar processing to the above-mentioned one is executed.

[Step 212]

The guidance plan generating unit 303 selects a guidance plan that has currently the highest evaluation value, and then notifies the selected guidance plan to the guidance plan execution unit 308. As a result, a guidance plan to be executed by the guidance apparatus 300 has been determined.

Next, “2. Executing the guidance plan” is described below.

In accordance with the situation of the user 312 provided from the recognition unit 301, the guidance plan execution unit 308 executes the guidance tools included in the guidance plan. The results of execution of the guidance tool is presented on the information display device by the presentation unit 309. For example, when the guidance plan B shown in FIG. 26 is executed for the user wearing the HMD shown in FIG. 2, BGM is first presented through the headphones 14. Then, a cheering video by a character is presented on the display device 12. Finally, an examination schedule is presented on the display device 12.

Next, “3. Setting a guidance goal” is described below.

The user 312 sets a goal of guiding own mental state, through the goal setting unit 310. The setting mode is not limited to a particular one. That is, the setting of a guidance goal may be prompted by generating and displaying a Web page. Further, the guidance goal may be set by voice input.

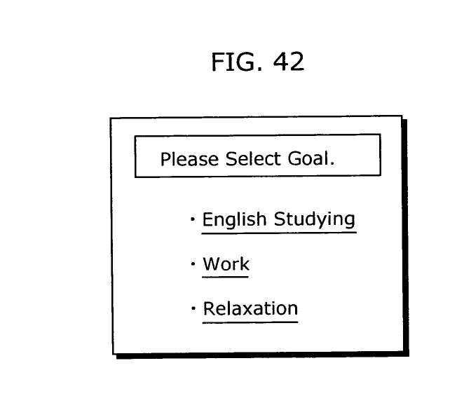

FIG. 42 shows an example of a GUI presented by the goal setting unit 310. The user 312 can select own guidance goal through this GUI.

As described above, according to the guidance apparatus of the present fourth embodiment, the user can be guided in a planed and stepwise manner. That is, a guidance plan consisting of a plurality of guidance tools can be made. Then, a mental state change in response to each of the guidance plans having been made is predicted so that these predictions are evaluated and compared with each other from the perspective of the guidance goal and the mental state change rule. Then, a guidance plan having the highest evaluation is executed. This permits guiding of the mental state of the user such that the English study willingness should be improved.

Here, the above mentioned processing procedures 1-3 need not be performed in order and may be performed simultaneously. For example, in the course of execution of a guidance plan, a new guidance plan may be generated and evaluated. Similarly, in the course of execution of a guidance plan, the user 312 may set a new guidance goal.

Further, the above-mentioned description has been given for the case that the mental state change predicted by the mental state change prediction unit 304 is evaluated on the basis of the degree of discrepancy from the ideal mental state change. However, the present invention is not limited to this particular example. That is, the mental state change predicted by the mental state change prediction unit 304 may be evaluated without using the ideal mental state change graph.

For example, a passing threshold to a mental resource may be prepared for each guidance goal. Then, when the maximum value of the expected mental state change exceeds this passing threshold, an evaluation of 100 points may be imparted uniformity. Otherwise, an evaluation of zero point may be provided. According to this approach, for example, in a case that the guidance goal is “learning”, when the maximum value of concentration exceeds 50, the evaluation value is set into 100.

Alternatively, the type of a necessary mental resource may be set. Then, for the set mental state, a higher evaluation may be imparted for a higher integration value of the result predicted by the mental state change prediction unit 304. According to this approach, for example, in a case that the guidance goal is “learning”, when the mental state change prediction unit 304 can predict “concentration” and “stress”, the integration value in the prediction graph for “concentration” can be adopted as the evaluation value.

### INDUSTRIAL APPLICABILITY

The guidance apparatus according to the present invention is applicable also to a head mounted display, a face mounted display, a goggle-type display, or the like in which the mental state of a user need be guided in a medium-to-long term.

What is claimed is:

1. A guidance apparatus which guides a mental state of a user, said apparatus comprising:
a goal setting unit operable to set a guidance goal of the user;
a recognition unit operable to recognize a situation of the user;
a guidance tool obtainment unit operable to obtain a guidance tool for the user;
a guidance plan making unit operable to make at least one guidance plan which matches the recognized situation and the set guidance goal, by combining two or more guidance tools obtained;
an execution unit operable to execute the made guidance plan; and
a presentation unit operable to present a result of the execution of the guidance plan.

2. The guidance apparatus according to claim 1,
wherein said guidance plan making unit includes:
a guidance plan generating unit operable to generate at least one guidance plan; and
a mental state change prediction unit operable to predict a change in the mental state of the user, which should be caused when the guidance plan is executed, and
said execution unit is operable to execute the guidance plan, which corresponds to the predicted change satisfying predetermined conditions, the corresponding predicted change being among the changes predicted by said mental state change prediction unit.

3. The guidance apparatus according to claim 2, further comprising
a mental state change rule obtainment unit operable to obtain a rule regarding the change in the mental state of the user,
wherein said mental state change prediction unit is operable to predict the change based on the obtained rule.

4. The guidance apparatus according to claim 3,
wherein the rule is described by a formula for setting an upper limit to a changing speed of a prediction value of the mental state.

5. The guidance apparatus according to claim 3,
wherein the rule is described by a formula for setting an upper limit to a total of the prediction values of the mental state in a predetermined time period.

6. The guidance apparatus according to claim 3,
wherein the rule is described by a formula for restricting an increase of a prediction value of a second mental state, when a prediction value of a first mental state is equal to or greater than a predetermined value.

7. The guidance apparatus according to claim 2, further comprising
an evaluation unit operable to evaluate the guidance plan, generated by said guidance plan generating unit, based on the predicted change in the mental state.

8. The guidance apparatus according to claim 7,
wherein said evaluation unit includes
a goal achievement evaluation unit operable to evaluate the predicted change based on the set guidance goal.

9. The guidance apparatus according to claim 7, further comprising
a mental state change rule obtainment unit operable to obtain a rule regarding the mental state of the user,
wherein said evaluation unit includes
a mental state resistance evaluation unit operable to evaluate a resistance in the mental state which should be caused by the predicted change in the mental state, based on the obtained rule.

10. The guidance apparatus according to claim 7, further comprising
a mental state change rule obtainment unit operable to obtain a rule regarding the mental state of the user,
wherein said evaluation unit includes:
a goal achievement evaluation unit operable to evaluate the predicted change based on the set guidance goal;
a mental state resistance evaluation unit operable to evaluate a resistance of the mental state which should be caused by the predicted change in the mental state, based on the obtained rule; and
a comprehensive evaluation unit operable to perform comprehensive evaluation, base on a result evaluated by said goal achievement evaluation unit, and a result evaluated by said mental state resistance evaluation unit.

11. The guidance apparatus according to claim 8,
wherein said goal achievement evaluation unit is operable to evaluate the predicted change in the mental state, based on an estrangement degree between the predicted change and an ideal change in the mental state.

12. The guidance apparatus according to claim 9,
wherein the rule is described as a function which indicates the rule.

13. The guidance apparatus according to claim 9,
wherein the rule is a changing speed rule which indicates that a resistance of the mental state is being increased, when a value indicating a level of the mental state is being increased with a speed faster than a predetermined speed.

14. The guidance apparatus according to claim 9,
wherein the rule is a tension duration rule which indicates that the resistance of the mental state is caused in the user, when a value indicating a level of the mental state is greater than a predetermined value.

15. The guidance apparatus according to claim 10,
wherein said comprehensive evaluation unit is operable to (i) assign different weighting coefficients to a result evaluated by said goal achievement evaluation unit and a result evaluated by said mental state resistance evaluation unit, respectively, depending on the set guidance goal, and (ii) perform comprehensive evaluation base on the weighting coefficients.

16. The guidance apparatus according to claim 1,
wherein said recognition unit is operable to recognize the situation of the user, using one of a camera, a global positioning system (GPS), an acceleration sensor, an angle sensor, a magnetic sensor, or an electronic tag sensor.

17. The guidance apparatus according to claim 1,
wherein said guidance plan making unit is operable to make the guidance plan, by selecting two or more guidance tools from the guidance tools obtained by said guidance tool obtainment unit, and deciding a time period for executing the selected guidance tools.

18. The guidance apparatus according to claim 1,
wherein said execution unit is operable to execute the guidance plan, by reproducing one of video and audio.

19. A guidance method of guiding a mental state of a user, said method comprising:
setting a guidance goal of the user;
recognizing a situation of the user;
obtaining a guidance tool for the user;
making at least one guidance plan matching the recognized situation and the set guidance goal, by combining two or more guidance tools obtained;
executing the made guidance plan; and
presenting a result of said executing.

20. A program for guiding a mental state of a user, said program causing a computer to execute comprising:
setting a guidance goal of the user;
recognizing a situation of the user;
obtaining a guidance tool for the user;
making at least one guidance plan matching the recognized situation and the set guidance goal, by combining two or more guidance tools obtained;
executing the made guidance plan; and
presenting a result of said executing.
